(19) United States
(12) Patent Application Publication
(10) Pub. No.: US 2026/0233517 A1
(43) Pub. Date: Aug. 13, 2026

(54) Liquid Ejecting Apparatus

(71) Applicant: SEIKO EPSON CORPORATION, Tokyo (JP)

(72) Inventors: Yuki WATANABE, Matsumoto (JP); Shunya FUKUDA, Azumino (JP); Nobuaki ITO, Suwa (JP); Kenichiro MATSUO, Matsumoto (JP); Shotaro WATANABE, Suwa (JP); Yoshitaka MATSUBARA, Shiojiri (JP)

(21) Appl. No.: 19/538,008

(22) Filed: Feb. 12, 2026

(30) Foreign Application Priority Data
Feb. 13, 2025 (JP) 2025-021359

(51) Int. Cl. B41J 2/045; B41J 2/14

(52) U.S. Cl. CPC B41J 2/04588; B41J 2/04508; B41J 2/0455; B41J 2/04581; B41J 2/14233; B41J 2002/14491; B41J 2202/07

(57) ABSTRACT

the drive circuit applies an ejection waveform for driving one piezoelectric element to such an extent that the liquid is ejected, via the first wiring, to the one piezoelectric element, applies a micro-vibration waveform for driving the one piezoelectric element to such an extent that the liquid is not ejected, via the second wiring, to the one piezoelectric element, and applies a recovery waveform for driving the one piezoelectric element to such an extent that a state of a nozzle is recovered, via the first wiring, to the one piezoelectric element.

The present application is based on, and claims priority from JP Application Serial Number 2025-021359, filed February 13, 2025, the disclosure of which is hereby incorporated by reference herein in its entirety.

### BACKGROUND

### 1. Technical Field

The present disclosure relates to a liquid ejecting apparatus.

### 2. Related Art

In a liquid ejecting apparatus that ejects a liquid such as ink to a medium such as printing paper, there is a problem of an increase in viscosity of the liquid due to evaporation or the like of a solvent, such as moisture, contained in the liquid. For example, JP-A-2024-131427 discloses a liquid ejecting apparatus that includes a piezoelectric element, a pressure chamber in which pressure is applied to an internal liquid by drive of the piezoelectric element, and a nozzle through which the liquid can be ejected by the pressure, in which, in order to eliminate a local increase in viscosity near the nozzle, the piezoelectric element is applied with a micro-vibration waveform for driving the piezoelectric element to such an extent that the liquid is not ejected.

Ejection failure may occur when air bubbles are generated in the nozzle. Thus, it is conceivable to apply the micro-vibration waveform to the piezoelectric element in order to recover a state of the nozzle. However, the air bubbles in the nozzle cannot be sufficiently removed with the micro-vibration waveform, and the state of the nozzle may not be recovered. On the other hand, when a degree of stirring of the liquid in the nozzle is increased by, for example, an increased intensity of the micro-vibration waveform, the quality of an image formed at the medium may deteriorate due to an adverse effect on other nozzles.

### SUMMARY

According to an aspect of the present disclosure, there is provided a liquid ejecting apparatus using a liquid ejecting head including a plurality of piezoelectric elements, a plurality of pressure chambers to which pressure is applied to an internal liquid by drive of each of the plurality of piezoelectric elements, a plurality of nozzles through which the liquid is able to be ejected by the pressure applied by each of the plurality of pressure chambers, a drive circuit that drives each of the plurality of piezoelectric elements, a first wiring that is switched whether or not to be electrically coupled to each of the plurality of piezoelectric elements under control of the drive circuit, and a second wiring that is switched whether or not to be electrically coupled to each of the plurality of piezoelectric elements, separately from the first wiring, under control of the drive circuit, in which the drive circuit applies an ejection waveform for driving one piezoelectric element among the plurality of piezoelectric elements to such an extent that the liquid is ejected, via the first wiring, to the one piezoelectric element, applies a micro-vibration waveform for driving the one piezoelectric element to such an extent that the liquid is not ejected, via the second wiring, to the one piezoelectric element, and applies a recovery waveform for driving the one piezoelectric element to such an extent that a state of a nozzle corresponding to the one piezoelectric element is recovered, via the first wiring, to the one piezoelectric element.

According to another aspect of the present disclosure, there is provided a liquid ejecting apparatus using a liquid ejecting head including a plurality of piezoelectric elements, a plurality of pressure chambers to which pressure is applied to an internal liquid by drive of each of the plurality of piezoelectric elements, a plurality of nozzles through which the liquid is able to be ejected by the pressure applied by each of the plurality of pressure chambers, a drive circuit that drives each of the plurality of piezoelectric elements, a first wiring that is switched whether or not to be electrically coupled to each of the plurality of piezoelectric elements under control of the drive circuit, and a second wiring that is switched whether or not to be electrically coupled to each of the plurality of piezoelectric elements, separately from the first wiring, under control of the drive circuit, in which the drive circuit applies an ejection waveform for driving one piezoelectric element among the plurality of piezoelectric elements to such an extent that the liquid is ejected, via the first wiring, to the one piezoelectric element, applies a micro-vibration waveform for driving the one piezoelectric element to such an extent that the liquid is not ejected, via the second wiring, to the one piezoelectric element, and applies a recovery waveform having an intensity that is higher than an intensity of the micro-vibration waveform and is lower than an intensity of the ejection waveform, via the first wiring, to the one piezoelectric element.

According to still another aspect of the present disclosure, there is provided a liquid ejecting apparatus using a liquid ejecting head including a plurality of piezoelectric elements, a plurality of pressure chambers to which pressure is applied to an internal liquid by drive of each of the plurality of piezoelectric elements, a plurality of nozzles through which the liquid is able to be ejected by the pressure applied by each of the plurality of pressure chambers, a plurality of individual flow paths, a common supply flow path that communicates in common with the plurality of individual flow paths to supply the liquid to the plurality of individual flow paths, a common discharge flow path that communicates in common with the plurality of individual flow paths to discharge the liquid from the plurality of individual flow paths, and a drive circuit that drives each of the plurality of piezoelectric elements, in which each of the plurality of individual flow paths has one or more pressure chambers among the plurality of pressure chambers and communicates with one nozzle among the plurality of nozzles, and the drive circuit applies, to one piezoelectric element among the plurality of piezoelectric elements, an ejection waveform for driving the one piezoelectric element to such an extent that the liquid is ejected, a micro-vibration waveform for driving the one piezoelectric element to such an extent that the liquid is not ejected, and a recovery waveform for driving the one piezoelectric element to such an extent that a state of a nozzle corresponding to the one piezoelectric element is recovered and for causing an air bubble generated in the nozzle corresponding to the one piezoelectric element to flow into an individual flow path having a pressure chamber corresponding to the one piezoelectric element and thus for driving the one piezoelectric element to such an extent that the state of the nozzle corresponding to the one piezoelectric element is recovered.

### BRIEF DESCRIPTION OF THE DRAWINGS

FIG. 1 is a functional block diagram showing an example of a configuration of an ink jet printer according to a first embodiment.

FIG. 2 is a schematic diagram illustrating the ink jet printer.

FIG. 3 is an exploded perspective view of a head chip.

FIG. 4 is a cross-sectional view taken along a line IV-IV in FIG. 3.

FIG. 5 is a plan view of the head chip when viewed in a Z2 direction.

FIG. 6 is an enlarged cross-sectional view of the vicinity of a piezoelectric element.

FIG. 7 is a block diagram showing an example of a configuration of a head chip.

FIG. 8 is a diagram showing a timing chart for describing an operation in a recording period.

FIG. 9 is an explanatory diagram for describing generation of coupling state designation signals.

FIG. 10 is a diagram showing a state near a nozzle before a recovery operation is executed.

FIG. 11 is a diagram showing a state near the nozzle after the recovery operation is executed.

FIG. 12 is a diagram showing a flowchart showing an operation of a control section.

FIG. 13 is a diagram for describing an execution example of the flowchart shown in FIG. 12.

FIG. 14 is a diagram showing a flowchart showing the operation of the control section according to a second embodiment.

FIG. 15 is a diagram showing a timing chart for describing an operation in the recording period when a recording operation is required to be executed.

FIG. 16 is a diagram showing a timing chart for describing an operation in the recording period when the recording operation is not required to be executed.

FIG. 17 is a diagram showing a flowchart showing the operation of the control section according to a third embodiment.

### DESCRIPTION OF EMBODIMENTS

Hereinafter, embodiments for implementing the present disclosure will be described with reference to drawings. However, in each drawing, a dimension and a scale of each section are different from actual ones as appropriate. Further, the embodiments described below are preferred specific examples of the present disclosure and thus various technically preferred limitations are provided, but the scope of the present disclosure is not limited to such embodiments unless description for limiting the present disclosure is made in the following description.

### 1. First Embodiment

### 1-1. Overview of Ink Jet Printer 1

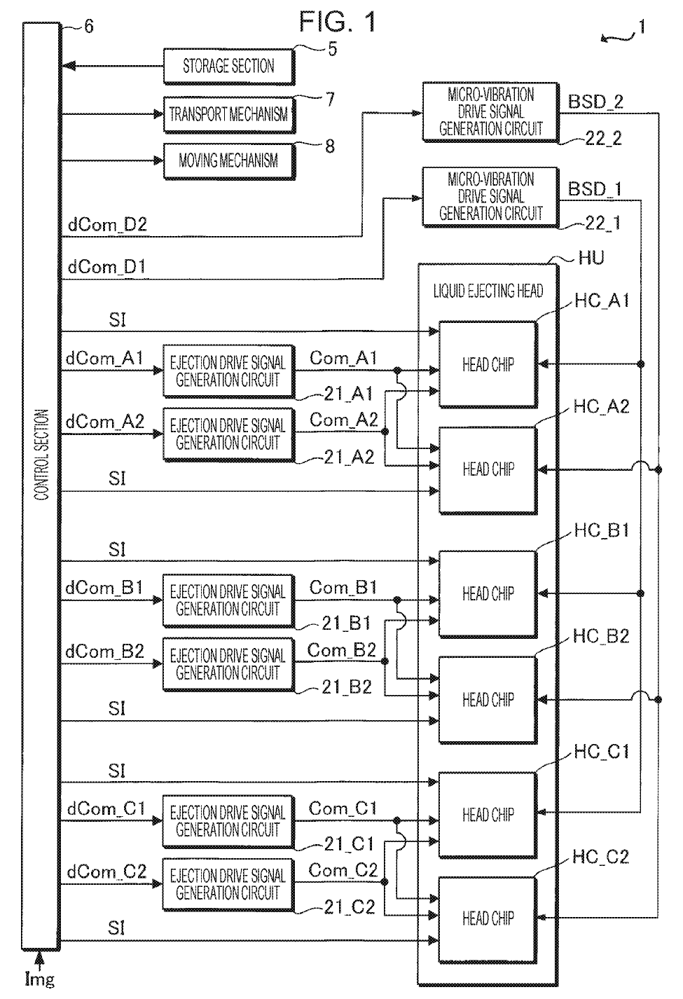

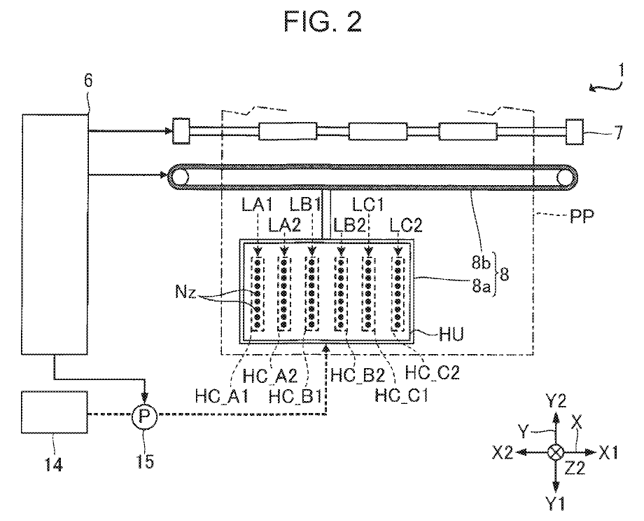

A configuration of an ink jet printer 1 will be described with reference to FIGS. 1 and 2. FIG. 1 is a functional block diagram showing an example of the configuration of the ink jet printer 1 according to a first embodiment. FIG. 2 is a schematic diagram illustrating the ink jet printer 1. The ink jet printer 1 is an ink jet-type printing apparatus that ejects ink, which is an example of "liquid", onto a medium PP. The medium PP is typically printing paper, but an optional printing target such as a resin film or fabric may be used as the medium PP. The ink jet printer 1 is an example of "liquid ejecting apparatus".

As illustrated in FIG. 2, the ink jet printer 1 includes a liquid container 14 that stores the ink. For example, a cartridge detachable from the ink jet printer 1, a bag-shaped ink pack formed of a flexible film, or an ink tank that can be replenished with the ink can be employed as the liquid container 14. The liquid container 14 stores a plurality of types of ink with different colors.

As illustrated in FIG. 1, the ink jet printer 1 includes six ejection drive signal generation circuits 21, two micro-vibration drive signal generation circuits 22, a liquid ejecting head HU, a control section 6, a storage section 5, a transport mechanism 7, a moving mechanism 8, and a circulation mechanism 15. The liquid ejecting head HU includes six head chips HC. In the following, each of the six ejection drive signal generation circuits 21 and each of the two micro-vibration drive signal generation circuits 22 may be referred to as the drive signal generation circuit 2 without distinction. Further, a signal generated by the drive signal generation circuit 2 may be referred to as a drive signal. Specific examples of the drive signal will be described below.

The ink jet printer 1 has, as the six ejection drive signal generation circuits 21, an ejection drive signal generation circuit 21_A1, an ejection drive signal generation circuit 21_A2, an ejection drive signal generation circuit 21_B1, an ejection drive signal generation circuit 21_B2, an ejection drive signal generation circuit 21_C1, and an ejection drive signal generation circuit 21_C2. The ink jet printer 1 has, as the two micro-vibration drive signal generation circuits 22, a micro-vibration drive signal generation circuit 22_1 and a micro-vibration drive signal generation circuit 22_2.

The control section 6 is, for example, a processing circuit such as a CPU or an FPGA. The CPU is an abbreviation for a central processing unit, and the FPGA is an abbreviation for a field programmable gate array. The control section 6 controls each element of the ink jet printer 1.

The storage section 5 is configured to include a volatile memory such as a RAM and a non-volatile memory such as a ROM, an EEPROM, or a PROM, and stores various types of information such as number of sheets information indicating the number of print sheets of an image required to be formed by the ink jet printer 1, medium information indicating a size of the medium PP, and a control program of the ink jet printer 1. Print data Img, the number of sheets information, and the medium information are transmitted from a host computer to the ink jet printer 1. The RAM is an abbreviation for a random access memory. The ROM is an abbreviation for a read only memory. The EEPROM is an abbreviation for an electrically erasable programmable read-only memory. The PROM is an abbreviation for a programmable ROM.

The transport mechanism 7 transports the medium PP in a Y1 direction along a Y-axis under the control of the control section 6. In the following, the Y1 direction and a Y2 direction opposite to the Y1 direction are collectively referred to as a direction along the Y-axis. Further, in the following, an X1 direction along an X-axis intersecting the Y-axis and an X2 direction opposite to the X1 direction are collectively referred to as a direction along the X-axis. Further, in the following, a Z1 direction along a Z-axis intersecting the X-axis and the Y-axis and a Z2 direction opposite to the Z1 direction are collectively referred to as a direction along the Z-axis. In the present embodiment, description will be made by assuming a case where the X-axis, the Y-axis, and the Z-axis are orthogonal to each other, as an example. However, the present disclosure is not limited to such an aspect. The X-axis, the Y-axis, and the Z-axis may intersect each other. Further, hereinafter, viewing in the direction along the Z-axis may be referred to as "plan view".

The transport mechanism 7 includes a transport roller (not illustrated) having a rotation shaft parallel to the X-axis, a transport motor (not illustrated) that rotates the transport roller under the control of the control section 6, and an encoder (not illustrated) that outputs, to the control section 6, a signal that corresponds to a rotation amount of the transport roller and corresponds to a transport position of the medium PP transported in response to a rotation drive of the transport roller.

The moving mechanism 8 reciprocates the liquid ejecting head HU in the X1 direction and the X2 direction under the control of the control section 6. As shown in FIG. 2, the moving mechanism 8 includes a housing case 8a that houses the liquid ejecting head HU, an endless belt 8b to which the housing case 8a is fixed, a motor (not illustrated) that rotates the endless belt 8b under the control of the control section 6, and an encoder (not illustrated) that outputs, to the control section 6, a signal that corresponds to a rotation amount of the motor and corresponds to a position of the liquid ejecting head HU moved in response to a rotation drive of the motor. The liquid container 14 and the circulation mechanism 15 may be housed in the housing case 8a together with the liquid ejecting head HU.

The ink jet printer 1 transports the medium PP in the Y1 direction, which is a sub-scanning direction, moves the liquid ejecting head HU in the X1 direction and the X2 direction, which are main scanning directions, and ejects the ink from a nozzle Nz to form an image on the medium PP. Hereinafter, the operation of ejecting the ink to the medium PP may be referred to as "recording operation".

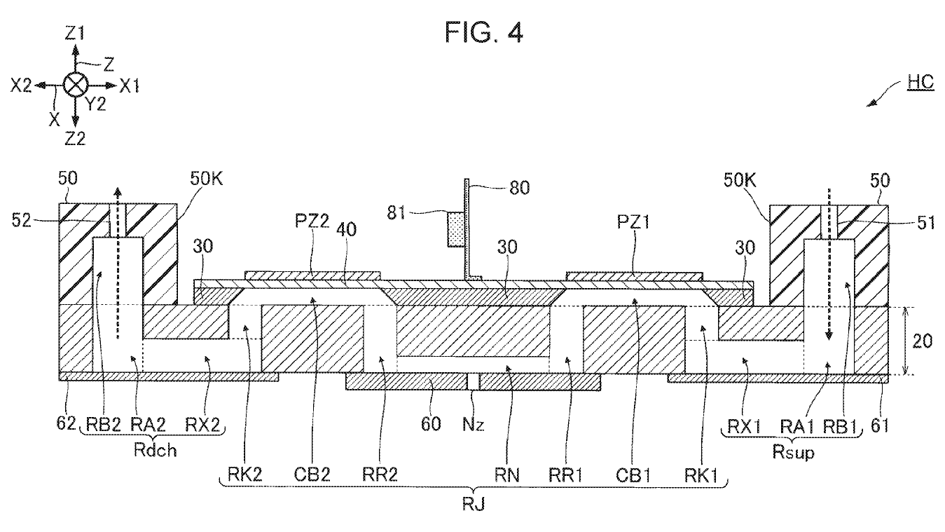

The circulation mechanism 15 supplies the ink stored in the liquid container 14 to a supply flow path RB1 provided in the liquid ejecting head HU, under the control of the control section 6. Further, the circulation mechanism 15 collects the ink stored in a discharge flow path RB2 provided in the liquid ejecting head HU and returns the collected ink to the supply flow path RB1, under the control of the control section 6. The supply flow path RB1 and the discharge flow path RB2 will be described below with reference to FIG. 4.

The liquid ejecting head HU has, as the six head chips HC, a head chip HC_A1, a head chip HC_A2, a head chip HC_B1, a head chip HC_B2, a head chip HC_C1, and a head chip HC_C2. Hereinafter, the head chip HC_A1, the head chip HC_A2, the head chip HC_B1, the head chip HC_B2, the head chip HC_C1, and the head chip HC_C2 may be referred to as the head chip HC without distinction.

Each of the six head chips HC has one nozzle row Ln. The nozzle row Ln has M nozzles Nz. M is an integer of 2 or more. Hereinafter, for simplification of the description, each of the six head chips HC has one nozzle row Ln. Specifically, as shown in FIG. 2, the head chip HC_A1 has a nozzle row LA1, and the head chip HC_A2 has a nozzle row LA2. The head chip HC_B1 has a nozzle row LB1, and the head chip HC_B2 has a nozzle row LB2. The head chip HC_C1 has a nozzle row LC1, and the head chip HC_C2 has a nozzle row LC2. Hereinafter, the nozzle row LA1, the nozzle row LA2, the nozzle row LB1, the nozzle row LB2, the nozzle row LC1, and the nozzle row LC2 may be referred to as the nozzle row Ln without distinction.

The above recording operation is an operation in which one or more nozzles Nz, among all the nozzles Nz of the liquid ejecting head HU, eject the ink onto the medium PP.

### 1-2. Overview of Head Chip HC

As shown in FIG. 2, the six head chips HC each extend in the direction along the Y-axis, and are disposed side by side along the X-axis. An extending direction of the nozzle row Ln included in each of the six head chips HC matches the extending direction of the head chip HC. Therefore, the nozzle rows Ln included in the respective six head chips HC also extend in the direction along the Y-axis, and are disposed side by side along the X-axis. However, the disposition of the head chips HC is not limited to FIG. 2. Further, in the present embodiment, the liquid ejecting head HU has the six nozzle rows Ln, but may have one or more nozzle rows Ln.

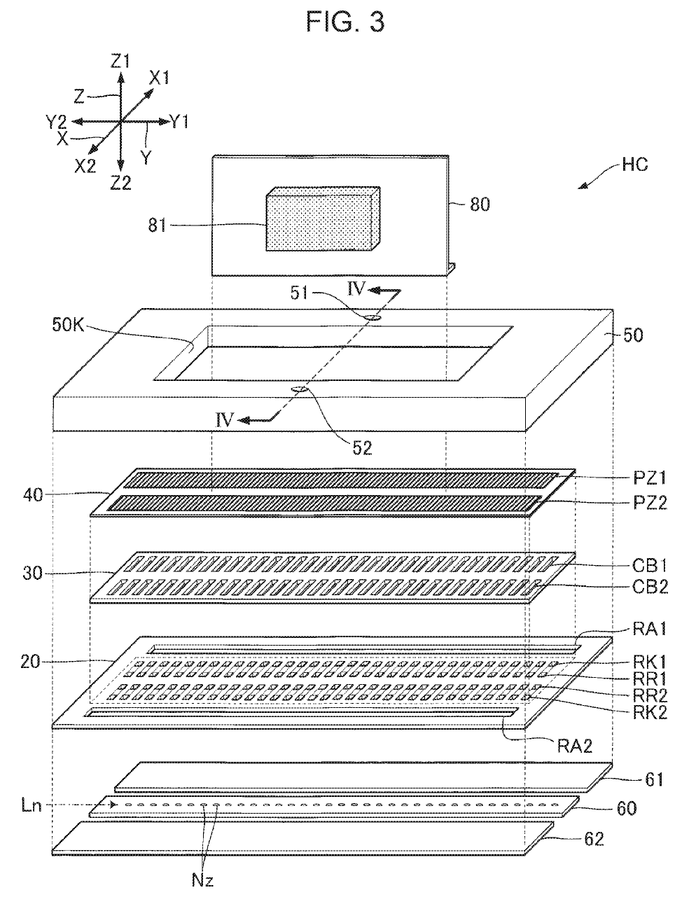

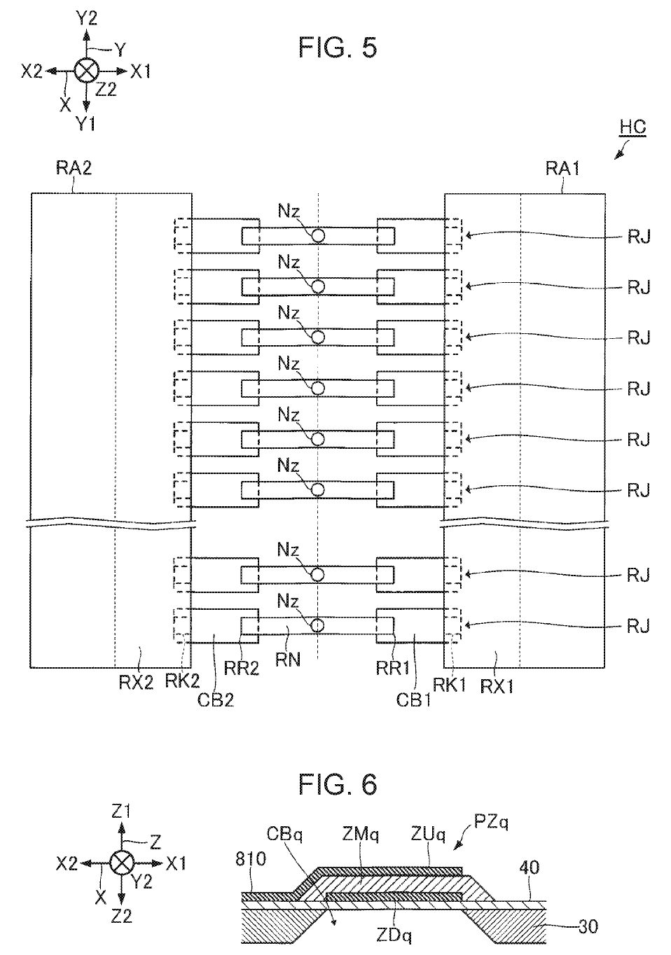

Hereinafter, an overview of the head chip HC will be described with reference to FIGS. 3 to 6. FIG. 3 is an exploded perspective view of the head chip HC, FIG. 4 is a cross-sectional view taken along a line IV-IV in FIG. 3, and FIG. 5 is a plan view of the head chip HC when viewed in the Z2 direction.

As illustrated in FIGS. 3 and 4, the head chip HC includes a nozzle substrate 60, a compliance sheet 61 and a compliance sheet 62, a communication plate 20, a pressure chamber substrate 30, a vibration plate 40, a storage chamber formation substrate 50, and a wiring substrate 80.

As illustrated in FIG. 3, the nozzle substrate 60 is a plate-shaped member that is long in the Y-axis direction and extends substantially parallel to an XY plane, and is formed with the M nozzles Nz. The "substantially parallel" is a concept that includes not only a case of being completely parallel but also a case of being regarded as being parallel in consideration of an error. For example, a silicon single crystal substrate is processed by using a semiconductor manufacturing technique such as etching to manufacture the nozzle substrate 60. However, any known material and manufacturing method may be employed for the manufacture of the nozzle substrate 60. Further, the nozzle Nz is a through-hole provided in the nozzle substrate 60. In the present embodiment, a case is assumed, as an example, in which the M nozzles Nz are provided on the nozzle substrate 60 to form the nozzle row Ln extending in the Y-axis direction.

As illustrated in FIGS. 3 and 4, the communication plate 20 is provided in the Z1 direction of the nozzle substrate 60. The communication plate 20 is a plate-shaped member that is long in the Y-axis direction and extends substantially parallel to the XY plane, and is formed with an ink flow path.

Specifically, the communication plate 20 is formed with one supply flow path RA1 and one discharge flow path RA2. Among the above flow paths, the supply flow path RA1 is provided to communicate with the supply flow path RB1 described below and to extend in the Y-axis direction. Further, the discharge flow path RA2 is provided to communicate with the discharge flow path RB2 described below and to extend in the Y-axis direction in the X2 direction when viewed from the supply flow path RA1.

Further, the communication plate 20 is formed with M nozzle flow paths RN corresponding to the M nozzles Nz in a one-to-one relationship, M communication flow paths RR1 corresponding to the M nozzles Nz in a one-to-one relationship, M communication flow paths RR2 corresponding to the M nozzles Nz in a one-to-one relationship, M communication flow paths RK1 corresponding to the M nozzles Nz in a one-to-one relationship, M communication flow paths RK2 corresponding to the M nozzles Nz in a one-to-one relationship, one communication flow path RX1 common to the M nozzles Nz, and one communication flow path RX2 common to the M nozzles Nz. The communication plate 20 may be provided with M communication flow paths RX1 corresponding to the M nozzles Nz in a one-to-one relationship, and M communication flow paths RX2 corresponding to the M nozzles Nz in a one-to-one relationship.

Among the above flow paths, the communication flow path RX1 is provided to communicate with the supply flow path RA1 and to extend in the X-axis direction in the X2 direction when viewed from the supply flow path RA1. Further, the communication flow path RK1 is provided to communicate with the communication flow path RX1 at an end portion in the X2 direction and to extend in the Z-axis direction. Further, the communication flow path RR1 is provided to extend in the Z-axis direction in the X2 direction when viewed from the communication flow path RK1.

Further, the communication flow path RX2 is provided to communicate with the discharge flow path RA2 and to extend in the X-axis direction in the X1 direction when viewed from the discharge flow path RA2. Further, the communication flow path RK2 is provided to communicate with the communication flow path RX2 at an end portion in the Z2 direction and to extend in the Z-axis direction. Further, the communication flow path RR2 is provided to extend in the Z-axis direction, in the X1 direction when viewed from the communication flow path RK2 and in the X2 direction when viewed from the communication flow path RR1.

Further, the nozzle flow path RN is provided to communicate with the communication flow path RR1 and the communication flow path RR2 and to extend in the X-axis direction in the X2 direction when viewed from the communication flow path RR1 and in the X1 direction when viewed from the communication flow path RR2. The nozzle flow path RN communicates with the nozzle Nz corresponding to the nozzle flow path RN.

For example, a silicon single crystal substrate is processed by using the semiconductor manufacturing technique to manufacture the communication plate 20. However, any known material and manufacturing method may be employed for the manufacture of the communication plate 20.

As illustrated in FIGS. 3 and 4, the pressure chamber substrate 30 is provided in the Z1 direction of the communication plate 20. The pressure chamber substrate 30 is a plate-shaped member that is long in the Y-axis direction and extends substantially parallel to the XY plane, and is formed with an ink flow path.

Specifically, the pressure chamber substrate 30 is formed with M pressure chambers CB1 corresponding to the M nozzles Nz in a one-to-one relationship, and M pressure chambers CB2 corresponding to the M nozzles Nz in a one-to-one relationship. Among the above pressure chambers, the pressure chamber CB1 is provided to communicate with the communication flow path RK1 and the communication flow path RR1, to couple an end portion of the communication flow path RK1 in the X1 direction and an end portion of the communication flow path RR1 in the X2 direction, when viewed from the Z-axis direction, and to extend in the X-axis direction. Further, the pressure chamber CB2 is provided to communicate with the communication flow path RK2 and the communication flow path RR2, to couple an end portion of the communication flow path RK2 in the X2 direction and an end portion of the communication flow path RR2 in the X1 direction, when viewed from the Z-axis direction, and to extend in the X-axis direction.

For example, a silicon single crystal substrate is processed by using the semiconductor manufacturing technique to manufacture the pressure chamber substrate 30. However, any known material and manufacturing method may be employed for the manufacture of the pressure chamber substrate 30.

In the following, the ink flow path that communicates the supply flow path RA1 and the discharge flow path RA2 may be referred to as an individual flow path RJ. As illustrated in FIG. 5, the communication flow path RX1 and the communication flow path RX2 are communicated with each other by M individual flow paths RJ corresponding to the M nozzles Nz in a one-to-one relationship. As described above, each individual flow path RJ includes the communication flow path RK1 that communicates with the communication flow path RX1, the pressure chamber CB1 that communicates with the communication flow path RK1, the communication flow path RR1 that communicates with the pressure chamber CB1, the nozzle flow path RN that communicates with the communication flow path RR1, the communication flow path RR2 that communicates with the nozzle flow path RN, the pressure chamber CB2 that communicates with the communication flow path RR2, and the communication flow path RK2 that communicates with the pressure chamber CB2. In the present embodiment, a case is assumed, as an example, in which each individual flow path RJ extends in the X-axis direction.

As understood from FIG. 4, the individual flow path RJ is provided by the pressure chamber substrate 30 and the communication plate 20.

As illustrated in FIGS. 3 and 4, the vibration plate 40 is provided in the Z1 direction of the pressure chamber substrate 30. The vibration plate 40 is a plate-shaped member that is long in the Y-axis direction and extends substantially parallel to the XY plane, and is a member that can vibrate elastically.

As illustrated in FIGS. 3 and 4, M piezoelectric elements PZ1 corresponding to the M pressure chambers CB1 in a one-to-one relationship and M piezoelectric elements PZ2 corresponding to the M pressure chambers CB2 in a one-to-one relationship are provided in the Z1 direction of the vibration plate 40. In the following, the piezoelectric element PZ1 and the piezoelectric element PZ2 may be collectively referred to as a piezoelectric element PZq without distinction. The piezoelectric element PZq is a passive element that is deformed according to a potential change of the drive signal generated by the drive signal generation circuit 2. In the following, a subscript "q" may be added to a reference numeral indicating a component or a signal corresponding to the piezoelectric element PZq in the head chip HC.

FIG. 6 is an enlarged cross-sectional view of the vicinity of the piezoelectric element PZq. As illustrated in FIG. 6, the piezoelectric element PZq is a laminated body in which the piezoelectric body ZMq is interposed between a lower electrode ZDq to which a predetermined reference potential Vbs is supplied and an upper electrode ZUq to which the drive signal generated by the drive signal generation circuit 2 is supplied. The piezoelectric element PZq is, for example, a portion where the lower electrode ZDq, the upper electrode ZUq, and the piezoelectric body ZMq overlap each other when viewed in the Z2 direction. Further, a pressure chamber CBq is provided in the Z2 direction of the piezoelectric element PZq.

As described above, the piezoelectric element PZq is driven and deformed according to the potential change of the drive signal generated by the drive signal generation circuit 2. The vibration plate 40 vibrates in conjunction with the deformation of the piezoelectric element PZq. When the vibration plate 40 vibrates, a pressure in the pressure chamber CBq fluctuates. With the fluctuation of the pressure in the pressure chamber CBq, the ink filled inside the pressure chamber CBq is ejected from the nozzle Nz via a communication flow path RRq and the nozzle flow path RN.

As illustrated in FIGS. 3 and 4, the wiring substrate 80 is mounted on a surface of the vibration plate 40 facing the Z1 direction. The wiring substrate 80 is a part for electrically coupling the control section 6 and the head chip HC. As the wiring substrate 80, for example, a flexible wiring substrate, such as an FPC or an FFC, is preferably employed. The FPC is an abbreviation for a flexible printed circuit, and the FFC is an abbreviation for a flexible flat cable. A drive circuit 81 is mounted on the wiring substrate 80. The drive circuit 81 is an electric circuit that switches whether or not to supply the drive signal, which is generated by the drive signal generation circuit 2, to the piezoelectric element PZq, under control of a print signal SI. As illustrated in FIG. 6, the drive circuit 81 supplies the drive signal, which is generated by the drive signal generation circuit 2, to the upper electrode ZUq of the piezoelectric element PZq, via a wiring 810.

In the present embodiment, a case is assumed in which when the ink is ejected from the nozzle Nz, a waveform of the drive signal supplied, by the drive circuit 81, to the piezoelectric element PZ1 corresponding to the nozzle Nz is substantially the same as a waveform of the drive signal supplied, by the drive circuit 81, to the piezoelectric element PZ2 corresponding to the nozzle Nz. The "substantially the same" is a concept including not only a case of being completely the same but also a case of being regarded as being the same in consideration of an error.

In the following, in order to distinguish each of the M nozzles Nz included in one head chip HC, the nozzles may be referred to as a first stage, a second stage, ..., an M-th stage in order. Further, an m-stage nozzle Nz may be referred to as a nozzle Nz[m]. In the following description, the variable m is an integer satisfying 1 or more and M or less. Further, when a component, signal, or the like of the ink jet printer 1 corresponds to the number of stages m of the nozzle Nz[m], a subscript [m] indicating the correspondence with the number of stages m may be assigned to a reference numeral for representing the component, signal, or the like to express the component, signal, or the like. For example, the pressure chamber CBq corresponding to a piezoelectric element PZq[m] is a pressure chamber CBq[m] to which the pressure is applied by the piezoelectric element PZq[m]. Furthermore, the nozzle Nz corresponding to the piezoelectric element PZq[m] is the nozzle Nz[m] that communicates with the pressure chamber CBq[m] to which the pressure is applied by the piezoelectric element PZq[m]. When the piezoelectric element PZq[m] corresponds to "one piezoelectric element", the pressure chamber CBq[m] corresponds to "pressure chamber corresponding to one piezoelectric element", and the nozzle Nz[m] corresponds to "nozzle corresponding to one piezoelectric element". The individual flow path RJ provided with the pressure chamber CBq[m] corresponds to "individual flow path provided with pressure chamber corresponding to one piezoelectric element".

As illustrated in FIGS. 3 and 4, the storage chamber formation substrate 50 is provided in the Z1 direction of the communication plate 20. The storage chamber formation substrate 50 is a member that is long in the Y-axis direction, and is formed with an ink flow path.

Specifically, the storage chamber formation substrate 50 is formed with one supply flow path RB1 and one discharge flow path RB2. Among the above flow paths, the supply flow path RB1 is provided to communicate with the supply flow path RA1 and to extend in the Y-axis direction in the Z1 direction when viewed from the supply flow path RA1. Further, the discharge flow path RB2 is provided to communicate with the discharge flow path RA2 and to extend in the Y-axis direction in the Z1 direction when viewed from the discharge flow path RA2 and in the X2 direction when viewed from the supply flow path RB1.

Further, the storage chamber formation substrate 50 is provided with an introduction port 51 that communicates with the supply flow path RB1, and a discharge port 52 that communicates with the discharge flow path RB2. The supply flow path RB1 is supplied with the ink via the introduction port 51 from the liquid container 14. Further, the ink stored in the discharge flow path RB2 is collected via the discharge port 52. Further, the storage chamber formation substrate 50 is provided with an opening 50K. The pressure chamber substrate 30, the vibration plate 40, and the wiring substrate 80 are provided on an inner side of the opening 50K. The storage chamber formation substrate 50 is formed by, for example, injection molding of a resin material. However, any known material and manufacturing method may be employed for the manufacture of the storage chamber formation substrate 50.

In the present embodiment, the ink supplied from the liquid container 14 to the introduction port 51 flows into the supply flow path RA1, via the supply flow path RB1. A part of the ink flowing into the supply flow path RA1 flows into the pressure chamber CB1, via the communication flow path RX1 and the communication flow path RK1. Further, a part of the ink flowing into the pressure chamber CB1 flows into the pressure chamber CB2, via the communication flow path RR1, the nozzle flow path RN, and the communication flow path RR2. A part of the ink flowing into the pressure chamber CB2 is discharged from the discharge port 52, via the communication flow path RK2, the communication flow path RX2, the discharge flow path RA2, and the discharge flow path RB2. When the piezoelectric element PZ1 is driven by the drive signal generated by the drive signal generation circuit 2, a part of the ink filled inside the pressure chamber CB1 is ejected from the nozzle Nz, via the communication flow path RR1 and the nozzle flow path RN. Further, when the piezoelectric element PZ2 is driven by the drive signal generated by the drive signal generation circuit 2, a part of the ink filled inside the pressure chamber CB2 is ejected from the nozzle Nz, via the communication flow path RR2 and the nozzle flow path RN.

As illustrated in FIGS. 3 and 4, the compliance sheet 61 is provided on a surface of the communication plate 20 facing the Z2 direction to close the supply flow path RA1, the communication flow path RX1, and the communication flow path RK1. The compliance sheet 61 is formed of an elastic material, and absorbs a pressure fluctuation of the ink in the supply flow path RA1, the communication flow path RX1, and the communication flow path RK1. Further, the compliance sheet 62 is provided on a surface of the communication plate 20 on a Z2 side to close the discharge flow path RA2, the communication flow path RX2, and the communication flow path RK2. The compliance sheet 62 is formed of an elastic material, and absorbs a pressure fluctuation of the ink in the discharge flow path RA2, the communication flow path RX2, and the communication flow path RK2.

As described above, the head chip HC according to the present embodiment causes the ink to circulate from the communication flow path RX1 to the communication flow path RX2 via the individual flow path RJ. Therefore, in the present embodiment, even when there is a period in which the ink inside the pressure chamber CBq is not ejected from the nozzle Nz, a state in which the ink is retained can be prevented from continuing inside the pressure chamber CBq and in the nozzle flow path RN and the like. Accordingly, in the present embodiment, even when there is the period in which the ink inside the pressure chamber CBq is not ejected from the nozzle Nz, an increase in viscosity of the ink inside the pressure chamber CBq can be suppressed, and thus occurrence of ejection abnormality in which the ink cannot be ejected from the nozzle Nz due to the increase in viscosity of the ink can be prevented.

As shown in FIG. 4, a common supply flow path Rsup is formed by the supply flow path RA1, the supply flow path RB1, and the communication flow path RX1. The common supply flow path Rsup communicates in common with the M individual flow paths RJ to supply the ink to each of the M individual flow paths RJ. Further, as shown in FIG. 4, a common discharge flow path Rdch is formed by the discharge flow path RA2, the discharge flow path RB2, and the communication flow path RX2. The common discharge flow path Rdch communicates in common with the M individual flow paths RJ to discharge the ink from each of the M individual flow paths RJ.

Further, the head chip HC according to the present embodiment can eject, from the nozzle Nz, the ink filled inside the pressure chamber CB1 and the ink filled inside the pressure chamber CB2. Therefore, in the head chip HC according to the present embodiment, for example, an ejection amount of the ink from the nozzle Nz can be increased, as compared with an aspect in which only the ink filled inside one pressure chamber CBq is ejected from the nozzle Nz.

As described above, each of the M individual flow paths RJ has two pressure chambers CBq out of 2 × M pressure chambers CBq, and communicates with one nozzle Nz out of the M nozzles Nz. The two pressure chambers CBq provided in one individual flow path RJ correspond to "one or more pressure chambers provided in each of the plurality of individual flow paths". However, one individual flow path RJ may not have two pressure chambers CBq, and may have only one pressure chamber CBq.

The description is returned to FIGS. 1 and 2. The control section 6 generates the print signal SI for controlling the head chip HC, a waveform designation signal dCom for controlling the drive signal generation circuit 2, a signal for controlling the transport mechanism 7, and a signal for controlling the moving mechanism 8.

The waveform designation signal dCom is a digital signal that defines a waveform of an ejection drive signal Com or a micro-vibration drive signal BSD. Further, the ejection drive signal Com and the micro-vibration drive signal BSD are analog signals for driving the piezoelectric element PZq. The drive signal generation circuit 2 includes a DA conversion circuit, and generates the ejection drive signal Com or the micro-vibration drive signal BSD having the waveform defined by the waveform designation signal dCom.

Specifically, the control section 6 outputs, to the ejection drive signal generation circuit 21_A1, a waveform designation signal dCom_A1 that defines an ejection drive signal Com_A1. The control section 6 outputs, to the ejection drive signal generation circuit 21_A2, a waveform designation signal dCom_A2 that defines an ejection drive signal Com_A2. The control section 6 outputs, to the ejection drive signal generation circuit 21_B1, a waveform designation signal dCom_B1 that defines an ejection drive signal Com_B1. The control section 6 outputs, to the ejection drive signal generation circuit 21_B2, a waveform designation signal dCom_B2 that defines an ejection drive signal Com_B2. The control section 6 outputs, to the ejection drive signal generation circuit 21_C1, a waveform designation signal dCom_C1 that defines an ejection drive signal Com_C1. The control section 6 outputs, to the ejection drive signal generation circuit 21_C2, a waveform designation signal dCom_C2 that defines an ejection drive signal Com_C2. The control section 6 outputs, to the micro-vibration drive signal generation circuit 22_1, a waveform designation signal dCom_D1 that defines a micro-vibration drive signal BSD_1. The control section 6 outputs, to the micro-vibration drive signal generation circuit 22_2, a waveform designation signal dCom_D2 that defines a micro-vibration drive signal BSD_2.

Further, the print signal SI is a digital signal for designating a type of operation of the piezoelectric element PZq. Specifically, the print signal SI designates whether or not the ejection drive signal Com is supplied to the piezoelectric element PZq or the micro-vibration drive signal BSD is supplied to the piezoelectric element PZq to designate whether or not the ink is ejected from the nozzle Nz when the piezoelectric element PZq is driven.

As understood from FIG. 1, the head chip HC_A1 is supplied with the ejection drive signal Com_A1 generated by the ejection drive signal generation circuit 21_A1, the ejection drive signal Com_A2 generated by the ejection drive signal generation circuit 21_A2, and the micro-vibration drive signal BSD_1 generated by the micro-vibration drive signal generation circuit 22_1. The head chip HC_A2 is supplied with the ejection drive signal Com_A1, the ejection drive signal Com_A2, and the micro-vibration drive signal BSD_2 generated by the micro-vibration drive signal generation circuit 22_2.

The head chip HC_B1 is supplied with the ejection drive signal Com_B1 generated by the ejection drive signal generation circuit 21_B1, the ejection drive signal Com_B2 generated by the ejection drive signal generation circuit 21_B2, and the micro-vibration drive signal BSD_1. The head chip HC_B2 is supplied with the ejection drive signal Com_B1, the ejection drive signal Com_B2, and the micro-vibration drive signal BSD_2.

The head chip HC_C1 is supplied with the ejection drive signal Com_C1 generated by the ejection drive signal generation circuit 21_C1, the ejection drive signal Com_C2 generated by the ejection drive signal generation circuit 21_C2, and the micro-vibration drive signal BSD_1. The head chip HC_C2 is supplied with the ejection drive signal Com_C1, the ejection drive signal Com_C2, and the micro-vibration drive signal BSD_2.

In the following description, the ejection drive signal Com_A1, the ejection drive signal Com_A2, the ejection drive signal Com_B1, the ejection drive signal Com_B2, the ejection drive signal Com_C1, and the ejection drive signal Com_C2 may be referred to as the ejection drive signal Com without distinction. Further, the micro-vibration drive signal BSD_1 and the micro-vibration drive signal BSD_2 may be referred to as the micro-vibration drive signal BSD without distinction. Further, the waveform for driving the piezoelectric element PZq to such an extent that the ink is ejected, which is included in the ejection drive signal Com, may be referred to as "ejection waveform". Further, the operation of applying the ejection waveform to the piezoelectric element PZq may be referred to as "ejection operation". The above recording operation may be an operation in which one or more piezoelectric elements PZq, among all the piezoelectric elements PZq of the liquid ejecting head HU, execute the ejection operation, in other words, an operation in which the ejection waveform is applied to one or more piezoelectric elements PZq. Further, the waveform for driving the piezoelectric element PZq to such an extent that the ink is not ejected, which is included in the micro-vibration drive signal BSD, may be referred to as "micro-vibration waveform WB". The operation of applying the micro-vibration waveform WB to the piezoelectric element PZq may be referred to as "micro-vibration operation".

### 1-3. Configuration of Head Chip HC

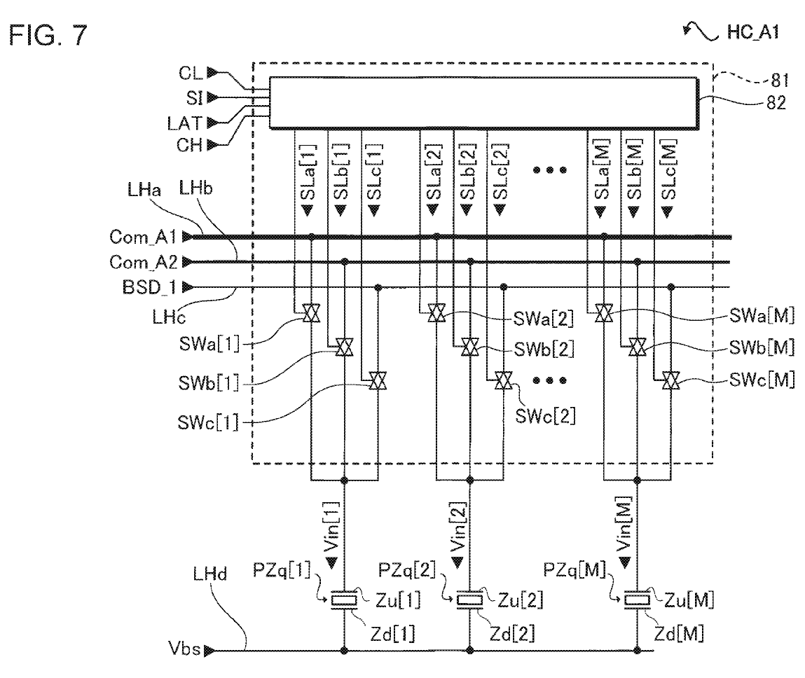

Hereinafter, a configuration of the head chip HC_A1 will be described with reference to FIG. 7.

FIG. 7 is a block diagram showing an example of the configuration of the head chip HC_A1. Further, the head chip HC_A1 includes an internal wiring LHa to which the ejection drive signal Com_A1 is supplied from the ejection drive signal generation circuit 21_A1, an internal wiring LHb to which the ejection drive signal Com_A2 is supplied from the ejection drive signal generation circuit 21_A2, an internal wiring LHc to which the micro-vibration drive signal BSD_1 is supplied from the micro-vibration drive signal generation circuit 22_1, and an internal wiring LHd to which a reference potential Vbs is supplied.

As shown in FIG. 7, the drive circuit 81 includes M switches SWa[1] to SWa[M], M switches SWb[1] to SWb[M], M switches SWc[1] to SWc[M], and a coupling state designation circuit 82 that designates a coupling state of each switch. For example, a transmission gate can be employed as each switch.

The coupling state designation circuit 82 generates, for each of 1 to M that the variable m may take, a coupling state designation signal SLa[m] that designates on/off of the switch SWa[m], a coupling state designation signal SLb[m] that designates on/off of the switch SWb[m], and a coupling state designation signal SLc[m] that designates on/off of the switch SWc[m], based on at least a part of the print signal SI, a latch signal LAT, and a change signal CH supplied from the control section 6.

For each of the variables m from 1 to M, the switch SWa[m] switches whether or not to electrically couple the internal wiring LHa and an upper electrode Zu[m] of the piezoelectric element PZq[m], in accordance with the coupling state designation signal SLa[m]. For example, the switch SWa[m] is turned on when the coupling state designation signal SLa[m] is at a high level and is turned off when the coupling state designation signal SLa[m] is at a low level.

For each of the variables m from 1 to M, the switch SWb[m] switches whether or not to electrically couple the internal wiring LHb and the upper electrode Zu[m] of the piezoelectric element PZq[m], in accordance with the coupling state designation signal SLb[m]. For example, the switch SWb[m] is turned on when the coupling state designation signal SLb[m] is at a high level and is turned off when the coupling state designation signal SLb[m] is at a low level.

For each of the variables m from 1 to M, the switch SWc[m] switches whether or not to electrically couple the internal wiring LHc and the upper electrode Zu[m] of the piezoelectric element PZq[m], in accordance with the coupling state designation signal SLc[m]. For example, the switch SWc[m] is turned on when the coupling state designation signal SLc[m] is at a high level and is turned off when the coupling state designation signal SLc[m] is at a low level.

Among the ejection drive signal Com_A1, the ejection drive signal Com_A2, and the micro-vibration drive signal BSD_1, a signal actually supplied to the piezoelectric element PZq[m], via the switch SWa[m], the switch SWb[m], or the switch SWc[m], may be referred to as a supply drive signal Vin[m].

As described above, the internal wiring LHa, the internal wiring LHb, and the internal wiring LHc are switched whether or not to be coupled to each of the 2 × M piezoelectric elements PZq, under the control of the drive circuit 81. In the first embodiment, the internal wiring LHb corresponds to "first wiring", and the internal wiring LHc corresponds to "second wiring".

Since a configuration of the head chip HC other than the head chip HC_A1 is the same as the configuration of the head chip HC_A1, an illustration thereof will be omitted. A configuration of the head chip HC_A2 has an internal wiring to which the micro-vibration drive signal BSD_2 is supplied from the micro-vibration drive signal generation circuit 22_2 instead of the internal wiring LHc, as compared with the configuration of the head chip HC_A1. A configuration of the head chip HC_B1 has an internal wiring to which the ejection drive signal Com_B1 is supplied from the ejection drive signal generation circuit 21_B1 instead of the internal wiring LHa, and has an internal wiring to which the ejection drive signal Com_B2 is supplied from the ejection drive signal generation circuit 21_B2 instead of the internal wiring LHb, as compared with the configuration of the head chip HC_A1. A configuration of the head chip HC_B2 has an internal wiring to which the micro-vibration drive signal BSD_2 is supplied from the micro-vibration drive signal generation circuit 22_2 instead of the internal wiring LHc, as compared with the configuration of the head chip HC_B1. A configuration of the head chip HC_C1 has an internal wiring to which the ejection drive signal Com_C1 is supplied from the ejection drive signal generation circuit 21_C1 instead of the internal wiring LHb, and has an internal wiring to which the ejection drive signal Com_C2 is supplied from the ejection drive signal generation circuit 21_C2 instead of the internal wiring LHa, as compared with the configuration of the head chip HC_A1. A configuration of the head chip HC_C2 has an internal wiring to which the micro-vibration drive signal BSD_2 is supplied from the micro-vibration drive signal generation circuit 22_2 instead of the internal wiring LHc, as compared with the configuration of the head chip HC_C1.

### 1-4. Micro-Vibration Waveform WB

In the ink jet printer 1, there is a problem of the increase in viscosity of the ink due to evaporation or the like of a solvent, such as moisture, contained in the ink. When the viscosity of the ink increases, ejection failure occurs. The ejection failure is a state in which an ejection characteristic of the nozzle Nz is lowered since the ink cannot be ejected according to an aspect defined by the ejection drive signal Com even when the piezoelectric element PZq is driven by the ejection drive signal Com to eject the ink from the nozzle Nz. The ejection characteristic is, for example, one or both of the ejection amount and an ejection speed. In order to eliminate a local increase in viscosity near the nozzle Nz, in the present embodiment, the micro-vibration drive signal BSD is applied to the piezoelectric element PZq. The micro-vibration drive signal BSD has the micro-vibration waveform WB for driving the piezoelectric element PZq to such an extent that the ink is not ejected.

Although details will be described below, an intensity of the micro-vibration waveform WB is lower than an intensity of the ejection waveform included in the ejection drive signal Com. The intensity of the waveform is indicated by, for example, a potential difference between a lowest potential and a highest potential in the waveform. Hereinafter, the potential difference may be referred to as a potential difference ΔVh. An increase in the intensity of the waveform means that the potential difference ΔVh of the waveform is large. However, the intensity of the waveform is not limited to the potential difference ΔVh, and may be, for example, an inclination of the potential change in the waveform. A ratio of the potential change is an absolute value of a magnitude obtained by dividing the potential difference between the potential changes in the waveform by a length of a period during which the potential changes.

Since the intensity of the micro-vibration waveform WB is lower than the intensity of the ejection waveform, a manufacturer of the liquid ejecting head HU can set a withstand voltage characteristic of the internal wiring LHc that supplies the micro-vibration waveform WB to be lower than a withstand voltage characteristic of the internal wiring LHa and the internal wiring LHb that supplies the ejection waveform. The withstand voltage characteristic of the wiring means a degree of the magnitude of a voltage that can be applied to the wiring. The larger the magnitude of the voltage that can be applied to the wiring, the higher the withstand voltage characteristic of the wiring. Shortening of a length of the wiring, thickening of the wiring, or the like is performed to increase the magnitude of the voltage that can be applied to the wiring. The shortening of the length of the wiring is not always possible. Further, the thickening of the wiring increases costs of the wiring and increases a size of a substrate on which the wiring is disposed. As described above, the withstand voltage characteristic of the wiring is preferably low when the voltage applied to the wiring is low. Therefore, the withstand voltage characteristic of the internal wiring LHc is preferably lower than the withstand voltage characteristics of the internal wiring LHa and the internal wiring LHb. In FIG. 7, the withstand voltage characteristic of each of the internal wiring LHa, the internal wiring LHb, and the internal wiring LHc is indicated by a line thickness. Among the internal wiring LHa, the internal wiring LHb, and the internal wiring LHc, the internal wiring LHa, which is a thickest line, has a highest withstand voltage characteristic, and the internal wiring LHc, which is a thinnest line, has a lowest withstand voltage characteristic.

The ejection failure may occur even when air bubbles are generated in the nozzle Nz, in addition to the increase in viscosity of the ink. Even when the air bubbles are generated in the nozzle Nz, the micro-vibration waveform WB is considered to be applied to the piezoelectric element PZq to remove the air bubbles from the nozzle Nz for recovery of the state of the nozzle Nz. However, the air bubbles in the nozzle Nz cannot be sufficiently removed with the micro-vibration waveform WB, and the state of the nozzle Nz may not be recovered. On the other hand, when a degree of stirring of the ink in the nozzle Nz is increased by, for example, an increased intensity of the micro-vibration waveform WB, in a specific situation such as during the execution of the recording operation, the pressure fluctuation is transmitted to the other nozzles Nz, and there may be adverse effects such as fluctuation in an amount of ink ejected from the other nozzles Nz and fluctuation in a speed of the ink. When the fluctuation in the amount of ink ejected from the other nozzles Nz and the fluctuation in the speed of the ink occur, the quality of an image formed at the medium PP deteriorates.

Therefore, it is conceivable to supply, to the piezoelectric element PZq, a recovery waveform WK for driving the piezoelectric element PZq to such an extent that the state of the nozzle Nz is recovered. When the recovery waveform WK is supplied to the piezoelectric element PZq via the internal wiring LHc, the withstand voltage characteristic of the internal wiring LHc may be exceeded, and a problem such as a short circuit with other wirings may occur. In the first embodiment, the recovery waveform WK is supplied to the piezoelectric element PZq via the internal wiring LHb. Hereinafter, the operation of supplying the recovery waveform WK to the piezoelectric element PZq may be referred to as "recovery operation".

### 1-5. Operation of Head Chip HC

In the present embodiment, an operation period of the ink jet printer 1 includes one or a plurality of recording periods Tu. In the following description, the operation period of the ink jet printer 1 is assumed to have I recording periods Tu. I is an integer of 1 or more. Further, an i-th recording period Tu may be referred to as a recording period Tu[i]. i is an integer from 1 to I. In the ink jet printer 1 according to the present embodiment, a case is assumed in which the drive of the piezoelectric element PZq is executed in any operation of the ejection operation, the micro-vibration operation, and the recovery operation in each recording period Tu[i]. In general, the ink jet printer 1 repeatedly executes the recording operation over I continuous or intermittent recording periods Tu to eject the ink one or a plurality of times from each nozzle to form an image indicated by the print data Img.

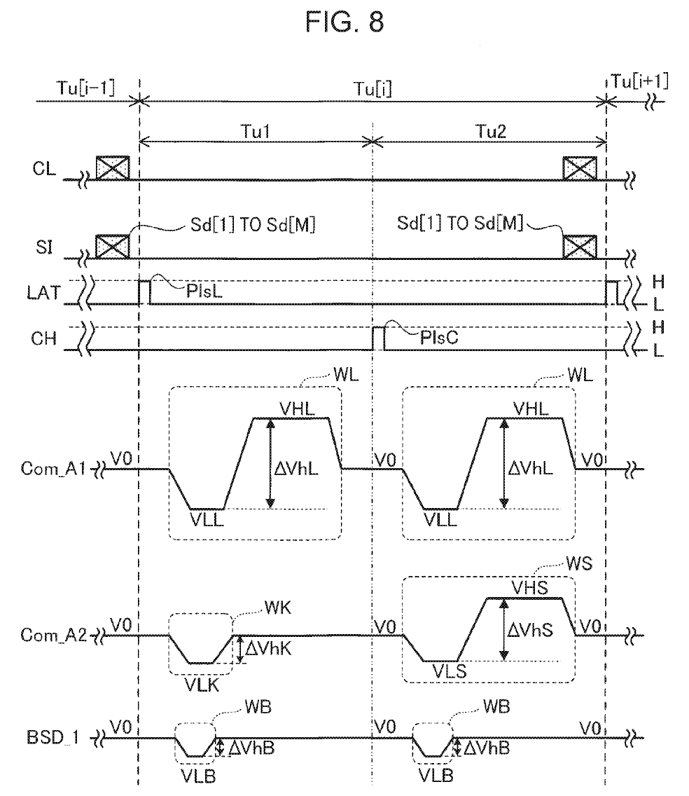

FIG. 8 is a timing chart for describing an operation of the ink jet printer 1 in the recording period Tu[i]. FIG. 8 illustrates the drive signals supplied to the head chip HC_A1, that is, the ejection drive signal Com_A1, the ejection drive signal Com_A2, and the micro-vibration drive signal BSD_1.

As shown in FIG. 8, the control section 6 outputs the latch signal LAT having a pulse PlsL and the change signal CH having a pulse PlsC. Accordingly, the control section 6 defines the recording period Tu[i] as a period from a rise of the pulse PlsL to a rise of a next pulse PlsL. A specific length or cycle of the recording period Tu[i] is not particularly limited. Further, the control section 6 divides the recording period Tu[i] into two control periods Tu1 and Tu2 using the pulse PlsC.

The print signal SI includes individual designation signals Sd[1] to Sd[M] that designate aspects of driving the piezoelectric elements PZq[1] to PZq[M] in each recording period Tu[i]. The control section 6 supplies, for each recording period Tu[i], the print signal SI including the individual designation signals Sd[1] to Sd[M] to the coupling state designation circuit 82 in synchronization with a clock signal CL before a start of the recording period Tu. The coupling state designation circuit 82 generates, for each of the integers m from 1 to M, the coupling state designation signal SLa[m], the coupling state designation signal SLb[m], and the coupling state designation signal SLc[m] based on an individual designation signal Sd[m] in the recording period Tu[i].

The individual designation signal Sd[m] is a signal that designates, for the piezoelectric element PZq[m], any one of the ejection operation of ejecting an amount of ink corresponding to a large dot, the ejection operation of ejecting an amount of ink corresponding to a medium dot, the ejection operation of ejecting an amount of ink corresponding to a small dot, the micro-vibration operation, and the recovery operation, in each recording period Tu[i].

As shown in FIG. 8, the ejection drive signal generation circuit 21_A1 outputs, in one recording period Tu, the ejection drive signal Com_A1 having two large-amount ejection waveforms WL. One of the two large-amount ejection waveforms WL is provided within the control period Tu1, and the other large-amount ejection waveform WL is provided within the control period Tu2.

As shown in FIG. 8, the ejection drive signal generation circuit 21_A2 outputs, in one recording period Tu, the ejection drive signal Com_A2 having the recovery waveform WK and a small-amount ejection waveform WS. The recovery waveform WK is provided within the control period Tu1, and the small-amount ejection waveform WS is provided within the control period Tu2. In the following, the large-amount ejection waveform WL and the small-amount ejection waveform WS may be referred to as the ejection waveform without distinction.

As shown in FIG. 8, the micro-vibration drive signal generation circuit 22_1 outputs, in one recording period Tu, the micro-vibration drive signal BSD_1 having two micro-vibration waveforms WB. One of the two micro-vibration waveforms WB is provided within the control period Tu1, and the other micro-vibration waveform WB is provided within the control period Tu2.

For simplification of the description, shapes of the two large-amount ejection waveforms WL are substantially the same, but may be different from each other. Similarly, shapes of the two micro-vibration waveforms WB may be substantially the same, but may be different from each other. Start potentials and end potentials of the large-amount ejection waveform WL, the small-amount ejection waveform WS, the recovery waveform WK, and the micro-vibration waveform WB are a reference potential V0. When the large-amount ejection waveform WL and the small-amount ejection waveform WS are applied to the piezoelectric element PZq, the ink is ejected from the nozzle Nz corresponding to the applied piezoelectric element PZq. On the other hand, when the recovery waveform WK and the micro-vibration waveform WB are applied to the piezoelectric element PZq, the ink is not ejected from the nozzle Nz corresponding to the applied piezoelectric element PZq. The large-amount ejection waveform WL and the small-amount ejection waveform WS are so-called pull-push-pull waveforms. The recovery waveform WK and the micro-vibration waveform WB are so-called pull-push waveforms.

In the present embodiment, the manufacturer of the ink jet printer 1 determines the large-amount ejection waveform WL and the small-amount ejection waveform WS such that a potential difference ΔVhL between a highest potential VHL and a lowest potential VLL of the large-amount ejection waveform WL is larger than a potential difference ΔVhS between a highest potential VHS and a lowest potential VLS of the small-amount ejection waveform WS. Hereinafter, the manufacturer of the ink jet printer 1 may be referred to as a printer manufacturer. The printer manufacturer determines the recovery waveform WK and the micro-vibration waveform WB such that a potential difference ΔVhK between the reference potential V0, which is a highest potential, and a lowest potential VLK of the recovery waveform WK is larger than a potential difference ΔVhB between the reference potential V0, which is a highest potential, and a lowest potential VLB of the micro-vibration waveform WB. The potential difference ΔVhS is larger than the potential difference ΔVhK.

In the present embodiment, the ink jet printer 1 applies two large-amount ejection waveforms WL to the piezoelectric element PZq, in one recording period Tu, to form large dots on the medium PP. Further, the ink jet printer 1 applies one large-amount ejection waveform WL and one small-amount ejection waveform WS to the piezoelectric element PZq, in one recording period Tu, to form medium dots on the medium PP. The ink jet printer 1 applies one large-amount ejection waveform WL to the piezoelectric element PZq, in one recording period Tu, to form small dots on the medium PP.

However, a method of forming the small dots is not limited to the application of one large-amount ejection waveform WL to the piezoelectric element PZq, and may also be to apply one small-amount ejection waveform WS to the piezoelectric element PZq. Further, when one small-amount ejection waveform WS is applied to the piezoelectric element PZq to form the small dots, one large-amount ejection waveform WL may be applied to the piezoelectric element PZq to form the medium dots.

For any m from 1 to M, when the individual designation signal Sd[m] designates, for the piezoelectric element PZq[m], the ejection operation of ejecting the amount of ink corresponding to the large dot, the coupling state designation circuit 82 sets the coupling state designation signal SLa[m] to a high level in the control periods Tu1 and Tu2, and sets the coupling state designation signals SLb[m] and SLc[m] to a low level in the recording period Tu. In this case, the large-amount ejection waveform WL is applied to the piezoelectric element PZq[m] in the control periods Tu1 and Tu2.

For any m from 1 to M, when the individual designation signal Sd[m] designates, for the piezoelectric element PZq[m], the ejection operation of ejecting the amount of ink corresponding to the medium dot, the coupling state designation circuit 82 sets the coupling state designation signal SLa[m] to a high level, and sets the coupling state designation signals SLb[m] and SLc[m] to a low level in the control period Tu1. Next, in the control period Tu2, the coupling state designation circuit 82 sets the coupling state designation signal SLb[m] to a high level, and sets the coupling state designation signals SLa[m] and SLc[m] to a low level. In this case, the large-amount ejection waveform WL is applied to the piezoelectric element PZq in the control period Tu1, and the small-amount ejection waveform WS is applied to the piezoelectric element PZq in the control period Tu2.

For any m from 1 to M, when the individual designation signal Sd[m] designates, for the piezoelectric element PZq[m], the ejection operation of ejecting the amount of ink corresponding to the small dot, the coupling state designation circuit 82 sets the coupling state designation signal SLc[m] to a high level, and sets the coupling state designation signals SLa[m] and SLb[m] to a low level in the control period Tu1. Next, in the control period Tu2, the coupling state designation circuit 82 sets the coupling state designation signal SLb[m] to a high level, and sets the coupling state designation signals SLa[m] and SLc[m] to a low level. In this case, the micro-vibration waveform WB is applied to the piezoelectric element PZq in the control period Tu1, and the small-amount ejection waveform WS is applied to the piezoelectric element PZq in the control period Tu2.

For any m from 1 to M, when the individual designation signal Sd[m] designates the micro-vibration operation for the piezoelectric element PZq[m], the coupling state designation circuit 82 sets the coupling state designation signal SLc[m] to a high level, and sets the coupling state designation signals SLa[m] and SLb[m] to a low level, in the control periods Tu1 and Tu2. In this case, the micro-vibration waveform WB is applied to the piezoelectric element PZq[m] in the control periods Tu1 and Tu2.

For any m from 1 to M, when the individual designation signal Sd[m] designates the recovery operation for the piezoelectric element PZq[m], the coupling state designation circuit 82 sets the coupling state designation signal SLb[m] to a high level, and sets the coupling state designation signals SLa[m] and SLc[m] to a low level, in the control period Tu1. Next, the coupling state designation circuit 82 sets the coupling state designation signal SLc[m] to a high level, and sets the coupling state designation signals SLa[m] and SLb[m] to a low level, in the control period Tu2. In this case, the recovery waveform WK is applied to the piezoelectric element PZq in the control period Tu1, and the micro-vibration waveform WB is applied to the piezoelectric element PZq in the control period Tu2.

In the first embodiment, the small-amount ejection waveform WS, which is supplied to the piezoelectric element PZq via the internal wiring LHb corresponding to the "first wiring", corresponds to the "ejection waveform".

In FIG. 8, the lowest potential VLK of the recovery waveform WK is higher than the lowest potential VLS of the small-amount ejection waveform WS, but may be lower. Further, the recovery waveform WK may be a pull-push-pull waveform. Further, one recovery waveform WK is provided in the control period Tu1, but a plurality of recovery waveforms WK may be provided.

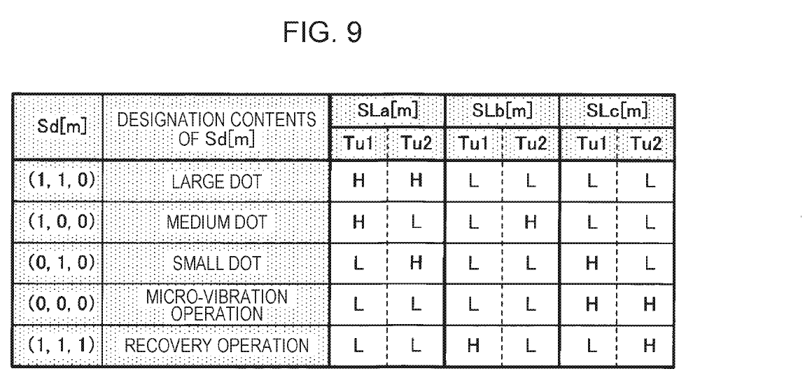

FIG. 9 is an explanatory diagram for describing the generation of the coupling state designation signals SLa[m], SLb[m], and SLc[m] for any m from 1 to M. The coupling state designation circuit 82 decodes the individual designation signal Sd[m] to generate the coupling state designation signals SLa[m], SLb[m], and SLc[m] in accordance with FIG. 9.

As shown in FIG. 9, the individual designation signal Sd[m] according to the present embodiment indicates any one of a value (1, 1, 0) that designates the ejection operation of ejecting the amount of ink corresponding to the large dot, a value (1, 0, 0) that designates the ejection operation of ejecting the amount of ink corresponding to the medium dot, a value (0, 1, 0) that designates the ejection operation of ejecting the amount of ink corresponding to the small dot, a value (0, 0, 0) that designates the micro-vibration operation, and a value (1, 1, 1) that designates the recovery operation.

When the individual designation signal Sd[m] indicates (1, 1, 0), the coupling state designation circuit 82 sets the coupling state designation signal SLa[m] to a high level in the control periods Tu1 and Tu2, and sets each signal to a low level when the above does not apply.

Further, when the individual designation signal Sd[m] indicates (1, 0, 0), the coupling state designation circuit 82 sets the coupling state designation signal SLa[m] to a high level in the control period Tu1, sets the coupling state designation signal SLb[m] to a high level in the control period Tu2, and sets each signal to a low level when the above does not apply.

Further, when the individual designation signal Sd[m] indicates (0, 1, 0), the coupling state designation circuit 82 sets the coupling state designation signal SLc[m] to a high level in the control period Tu1, sets the coupling state designation signal SLa[m] to a high level in the control period Tu2, and sets each signal to a low level when the above does not apply.

Further, when the individual designation signal Sd[m] indicates (0, 0, 0), the coupling state designation circuit 82 sets the coupling state designation signal SLc[m] to a high level in the control periods Tu1 and Tu2, and sets each signal to a low level when the above does not apply.

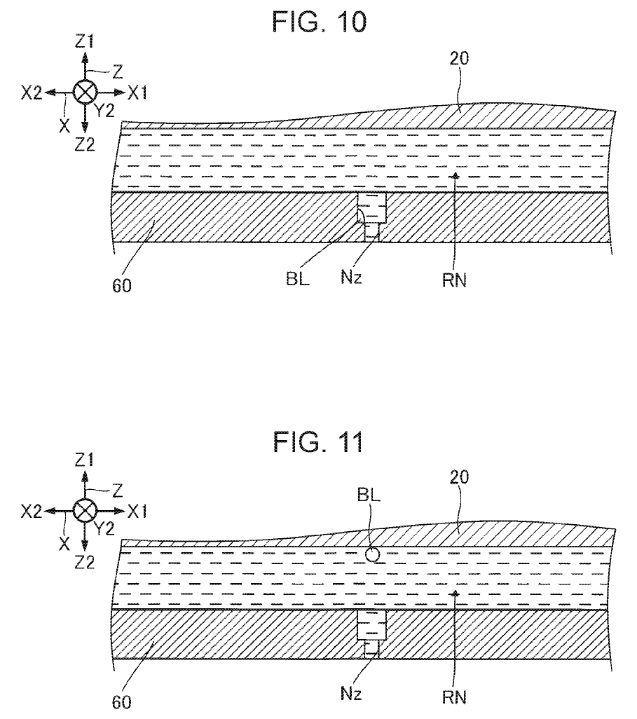

Further, when the individual designation signal Sd[m] indicates (1, 1, 1), the coupling state designation circuit 82 sets the coupling state designation signal SLb[m] to a high level in the control period Tu1, sets the coupling state designation signal SLc[m] to a high level in the control period Tu2, and sets each signal to a low level when the above does not apply. A change in a state near the nozzle Nz due to the execution of the recovery operation will be described with reference to FIGS. 10 and 11.

FIG. 10 is a diagram showing a state near the nozzle Nz before the recovery operation is executed. FIG. 11 is a diagram showing a state near the nozzle Nz after the recovery operation is executed. An air bubble BL is generated in the nozzle Nz shown in FIG. 10. From the state shown in FIG. 10, with the execution of the recovery operation by the drive circuit 81, the air bubble BL flows into the nozzle flow path RN, which is a part of the individual flow path RJ, as shown in FIG. 11. Therefore, the air bubble BL is not present in the nozzle Nz, and the state of the nozzle Nz is recovered. As described above, it can be said that the recovery waveform WK is for causing the air bubble BL generated in the nozzle Nz to flow into the individual flow path RJ, and thus for driving the piezoelectric element PZq to such an extent that the state of the nozzle Nz is recovered.

### 1-6. Operation of Control Section 6

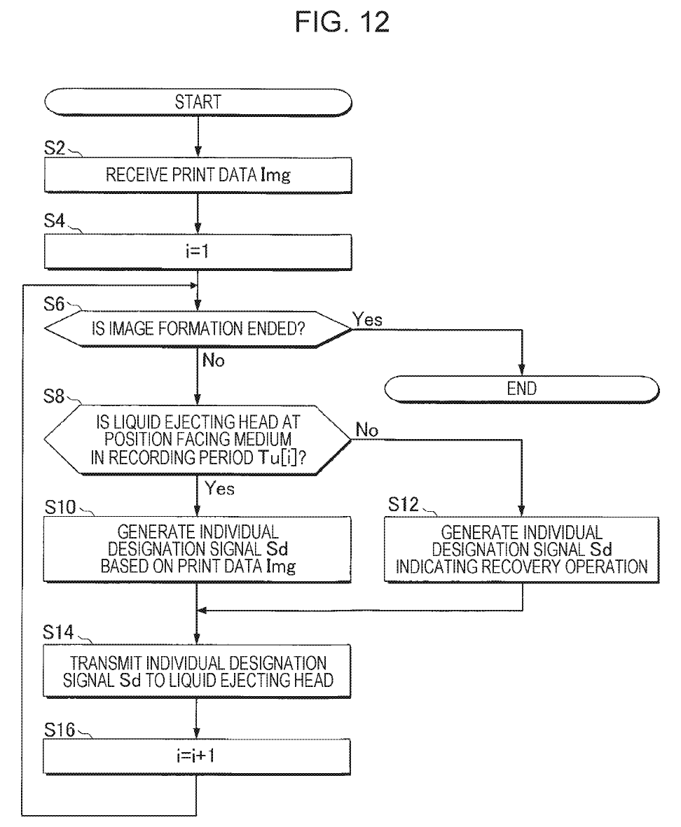

FIG. 12 is a flowchart showing the operation of the control section 6. In step S2, the control section 6 receives the print data Img from the host computer. Next, in step S4, the control section 6 substitutes 1 for the variable i. In step S6, the control section 6 determines whether or not the image formation on the medium PP is ended. When a determination result in the step S6 is positive, the control section 6 ends a series of pieces of processing shown in FIG. 12.

When the determination result in step S6 is negative, the control section 6 determines in step S8 whether or not the liquid ejecting head HU is at a position facing the medium PP in the recording period Tu[i]. The fact that the liquid ejecting head HU is at the position facing the medium PP means that the medium PP overlaps with the liquid ejecting head HU in plan view. In the present embodiment, when the medium PP partially overlaps with the liquid ejecting head HU in plan view, the liquid ejecting head HU is described as being at the position facing the medium PP.

As specific processing in step S8, the control section 6 specifies the position of the liquid ejecting head HU with respect to the medium PP in plan view, based on the signal corresponding to the transport position of the medium PP acquired from the encoder of the transport mechanism 7 and the signal corresponding to the position of the liquid ejecting head HU acquired from the encoder of the moving mechanism 8. Next, the control section 6 determines whether or not the medium PP overlaps with the liquid ejecting head HU in plan view, based on the position of the liquid ejecting head HU with respect to the medium PP in plan view and the medium information acquired from the host computer. When determination is made that the medium PP overlaps with the liquid ejecting head HU in plan view, the control section 6 determines that the liquid ejecting head HU is at the position facing the medium PP. On the other hand, when determination is made that the medium PP does not overlap with the liquid ejecting head HU in plan view, the control section 6 determines that the liquid ejecting head HU is at a position not facing the medium PP.

When the determination result in step S8 is positive, the control section 6 generates, in step S10, the individual designation signal Sd for all the piezoelectric elements PZq of the liquid ejecting head HU, based on the print data Img. Specifically, the control section 6 generates the individual designation signal Sd that designates, for all the piezoelectric elements PZq of the liquid ejecting head HU, any one of the ejection operation of ejecting the amount of ink corresponding to the large dot, the ejection operation of ejecting the amount of ink corresponding to the medium dot, the ejection operation of ejecting the amount of ink corresponding to the small dot, and the micro-vibration operation.

When the determination result in step S8 is negative, the control section 6 generates, in step S12, the individual designation signal Sd indicating the recovery operation for all the piezoelectric elements PZq of the liquid ejecting head HU.

After the processing of step S10 is ended or after the processing of step S12 is ended, the control section 6 transmits, in step S14, the individual designation signal Sd, which is generated by the processing of step S10 or the processing of step S12, to the liquid ejecting head HU before the recording period Tu[i] starts. The control section 6 increases a value of the variable i by 1 in step S16. After the processing of step S16 is ended, the control section 6 returns the processing to step S6.

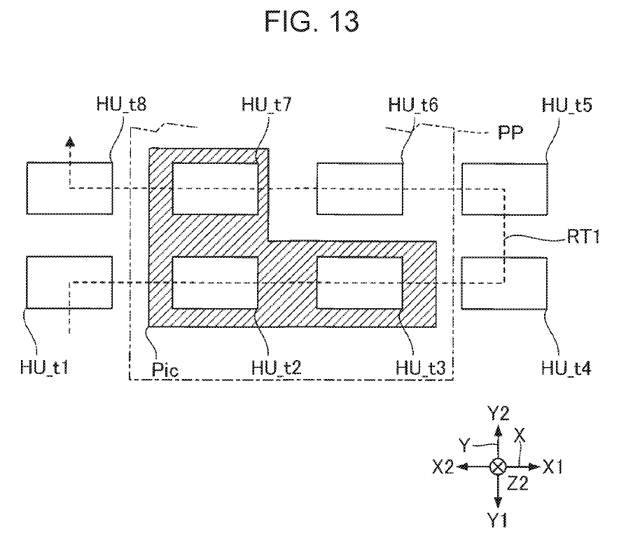

An execution example of the flowchart shown in FIG. 12 will be described with reference to FIG. 13.

FIG. 13 is a diagram for describing the execution example of the flowchart shown in FIG. 12. The ink jet printer 1 transports the medium PP in the Y1 direction as shown in FIG. 2, but the liquid ejecting head HU is displayed to move in the Y2 direction with respect to the medium PP in FIG. 13, as a display for convenience, for ease of understanding.

A route RT1 shown in FIG. 13 indicates a route in which the liquid ejecting head HU moves. Positions of the liquid ejecting head HU from a point in time t1 to a point in time t8 are shown on the route RT1. In FIG. 13, for ease of understanding, the liquid ejecting head HU at a point in time tx is displayed as a liquid ejecting head HU_tx when x is an integer from 1 to 8. Further, the medium PP shown in FIG. 13 is shown with a range Pic of the image formed at the medium PP.

As understood from FIG. 13, the liquid ejecting head HU at the point in time t1, a point in time t4, a point in time t5, and the point in time t8 is not at the position facing the medium PP. Therefore, at the points in time t1, t4, t5, and t8, the control section 6 determines that the determination result in step S8 is negative, and generates the individual designation signal Sd indicating the recovery operation in step S12.

On the other hand, the liquid ejecting head HU at a point in time t2, a point in time t3, a point in time t6, and a point in time t7 is at the position facing the medium PP. Therefore, at the points in time t2, t3, t6, and t7, the control section 6 determines that the determination result in step S8 is positive, and generates the individual designation signal Sd based on the print data Img in step S10. Specifically, the control section 6 generates the individual designation signal Sd that designates the ejection operation or the micro-vibration operation at the points in time t2, t3, and t7, and generates the individual designation signal Sd that designates the micro-vibration operation at the point in time t6.

### 1-7. Summary of First Embodiment

Hereinafter, for simplification of the description, one head chip HC, among the six head chips HC of the liquid ejecting head HU, will be focused on, and further, the piezoelectric element PZq[m] among the 2 × M piezoelectric elements PZq of one head chip HC will be described as "one piezoelectric element" in summarizing the first embodiment.

Hereinafter, the ink jet printer 1 according to the first embodiment has the liquid ejecting head HU including the head chip HC that has the 2 × M piezoelectric elements PZq, the 2 × M pressure chambers CBq to which the pressure is applied to the internal ink by the drive of each of the 2 × M piezoelectric elements PZq, the M nozzles Nz through which the ink can be ejected by the pressure applied by each of the 2 × M pressure chambers CBq, the drive circuit 81 that drives each of the 2 × M piezoelectric elements PZq, the internal wiring LHb that is switched whether or not to be electrically coupled to each of the 2 × M piezoelectric elements PZq under the control of the drive circuit 81, and the internal wiring LHc that can be electrically coupled to each of the 2 × M piezoelectric elements PZq separately from the internal wiring LHb under the control of the drive circuit 81. The drive circuit 81 applies, to the piezoelectric element PZq[m] via the internal wiring LHb, the small-amount ejection waveform WS for driving the piezoelectric element PZq[m] among the 2 × M piezoelectric elements PZq to such an extent that the ink is ejected, applies, to the piezoelectric element PZq[m] via the internal wiring LHc, the micro-vibration waveform WB for driving the piezoelectric element PZq[m] to such an extent that the ink is not ejected, and applies, to the piezoelectric element PZq[m] via the internal wiring LHb, the recovery waveform WK for driving the piezoelectric element PZq[m] to such an extent that the state of the nozzle Nz[m] corresponding to the piezoelectric element PZq[m] is recovered.

According to the first embodiment, with the application of the recovery waveform WK to the piezoelectric element PZq[m] via the internal wiring LHb, the occurrence of the short circuit or the like occurring when the recovery waveform WK is applied via the internal wiring LHc can be avoided, and the state of the nozzle Nz[m] can be recovered by the recovery waveform WK. Since the ejection failure is eliminated by the recovery of the state of the nozzle Nz[m], the deterioration of the quality of the image formed at the medium PP can be suppressed.

Further, the recovery waveform WK is for driving the piezoelectric element PZq[m] to such an extent that the ink is not ejected.

The recovery waveform WK may be a waveform for driving the piezoelectric element PZq[m] to such an extent that the ink is ejected, but the ink is consumed unnecessarily. Therefore, according to the first embodiment, the consumption of the ink can be reduced, as compared with the aspect in which the piezoelectric element PZq[m] is driven by the recovery waveform WK to eject the ink.

Further, the intensity of the recovery waveform WK is higher than the intensity of the micro-vibration waveform WB.

According to the first embodiment, even when the air bubble in the nozzle Nz cannot be removed by the micro-vibration waveform WB, the air bubble in the nozzle Nz can be removed by the recovery waveform WK having the higher intensity than the micro-vibration waveform WB.

Further, the intensity of the recovery waveform WK is lower than the intensity of the small-amount ejection waveform WS.

The intensity of the recovery waveform WK may be higher than the intensity of the small-amount ejection waveform WS. However, since the ink is ejected from the nozzle Nz when the small-amount ejection waveform WS is applied to the piezoelectric element PZq, there is a high possibility that the recovery waveform WK having the higher intensity than the small-amount ejection waveform WS causes the ink to be ejected from the nozzle Nz. Therefore, according to the first embodiment, the consumption of the ink can be reduced, as compared with the aspect in which the intensity of the recovery waveform WK is higher than the intensity of the small-amount ejection waveform WS.

One head chip HC of the liquid ejecting head HU further includes the M individual flow paths RJ, the common supply flow path Rsup that communicates in common with the M individual flow paths RJ to supply the ink to each of the plurality of individual flow paths RJ, and the common discharge flow path Rdch that communicates in common with the M individual flow paths RJ to discharge the ink from each of the M individual flow paths RJ. Each of the M individual flow paths RJ has one or more pressure chambers CBq among the 2 × M pressure chambers CBq, and communicates with one nozzle Nz among the M nozzles Nz.

According to the first embodiment, the aspect in which the recovery waveform WK is applied to the piezoelectric element PZq can be applied to the aspect in which the ink is circulated from the communication flow path RX1 to the communication flow path RX2 via the individual flow path RJ.

Further, the recovery waveform WK is for causing the air bubble generated in the nozzle Nz[m] corresponding to the piezoelectric element PZq[m] to flow into the individual flow path RJ[m] having the pressure chamber CBq[m] corresponding to the piezoelectric element PZq[m], and thus for driving the piezoelectric element PZq[m] to such an extent that the state of the nozzle Nz[m] is recovered.

In the aspect in which the ink is circulated from the communication flow path RX1 to the communication flow path RX2 via the individual flow path RJ, the air bubble is caused to flow from the inside of the nozzle Nz into the individual flow path RJ, and thus the air bubble flowing into the individual flow path RJ can be discharged to the outside of the liquid ejecting head HU by the flow of the ink generated in the individual flow path RJ.

Further, the liquid ejecting head HU ejects the ink onto the medium PP, and the drive circuit 81 executes, when the liquid ejecting head HU is at the position facing the medium PP, an operation selected by the control section 6 out of the ejection operation of applying the small-amount ejection waveform WS via the internal wiring LHb and the micro-vibration operation of applying the micro-vibration waveform WB via the internal wiring LHc, and executes, when the liquid ejecting head HU is at the position not facing the medium PP, the recovery operation of applying the recovery waveform WK via the internal wiring LHc.

When the liquid ejecting head HU is at the position not facing the medium PP, the ink is not ejected from all the nozzles Nz of the liquid ejecting head HU. Therefore, according to the first embodiment, since the recovery waveform WK is applied to the piezoelectric element PZq at a timing at which the quality of the image is not affected even when the recovery waveform WK is applied to the piezoelectric element PZq, the quality of the image formed at the medium PP can be maintained and the state of the nozzle Nz can be recovered.

Further, the withstand voltage characteristic of the internal wiring LHc is preferably lower than the withstand voltage characteristic of the internal wiring LHb.

According to the first embodiment, the costs of the internal wiring LHc and the substrate on which the internal wiring LHc is disposed can be reduced, as compared with the aspect in which the withstand voltage characteristic of the internal wiring LHc is higher than the withstand voltage characteristic of the internal wiring LHb.

Further, from the first embodiment, the following aspects can also be defined. The ink jet printer 1 has the liquid ejecting head HU including the head chip HC that has the 2 × M piezoelectric elements PZq, the 2 × M pressure chambers CBq to which the pressure is applied to the internal ink by the drive of the 2 × M piezoelectric elements PZq, the M nozzles Nz through which the ink can be ejected by the pressure applied by each of the 2 × M pressure chambers CBq, the drive circuit 81 that drives each of the 2 × M piezoelectric elements PZq, the internal wiring LHb that is switched whether or not to be electrically coupled to each of the 2 × M piezoelectric elements PZq under the control of the drive circuit 81, and the internal wiring LHc that is switched whether or not to be electrically coupled to each of the 2 × M piezoelectric elements PZq separately from the internal wiring LHb under the control of the drive circuit 81. The drive circuit 81 applies, to the piezoelectric element PZq[m] via the internal wiring LHb, the small-amount ejection waveform WS for driving the piezoelectric element PZq[m] among the 2 × M piezoelectric elements PZq to such an extent that the ink is ejected, applies, to the piezoelectric element PZq[m] via the internal wiring LHc, the micro-vibration waveform WB for driving the piezoelectric element PZq[m] to such an extent that the ink is not ejected, and applies, to the piezoelectric element PZq[m] via the internal wiring LHb, the recovery waveform WK having the intensity higher than the intensity of the micro-vibration waveform WB and lower than the intensity of the small-amount ejection waveform WS.

According to the above aspect, with the application of the recovery waveform WK having the intensity higher than the intensity of the micro-vibration waveform WB and lower than the intensity of the small-amount ejection waveform WS to the piezoelectric element PZq[m] via the internal wiring LHb, the occurrence of the short circuit or the like occurring when the recovery waveform WK is applied via the internal wiring LHc can be avoided, and the state of the nozzle Nz[m] can be recovered by the recovery waveform WK.

Further, from the first embodiment, the following aspects can also be defined. The ink jet printer 1 has the liquid ejecting head HU including the head chip HC that has the 2 × M piezoelectric elements PZq, the 2 × M pressure chambers CBq to which the pressure is applied to the internal ink by the drive of each of the 2 × M piezoelectric elements PZq, the M nozzles Nz through which the ink can be ejected by the pressure applied by each of the 2 × M pressure chambers CBq, the M individual flow paths RJ, the common supply flow path Rsup that communicates in common with the M individual flow paths RJ to supply the ink to the plurality of individual flow paths RJ, the common discharge flow path Rdch that communicates in common with the M individual flow paths RJ to discharge the ink from the M individual flow paths RJ, and the drive circuit 81 that drives each of the 2 × M piezoelectric elements PZq. Each of the M individual flow paths RJ is provided with one or more pressure chambers CBq among 2 × M pressure chambers CBq, and communicates with one nozzle Nz among the M nozzles Nz. The drive circuit 81 applies, to the piezoelectric element PZq[m], the small-amount ejection waveform WS for driving the piezoelectric element PZq[m] among the 2 × M piezoelectric elements PZq to such an extent that the ink is ejected, the micro-vibration waveform WB for driving the piezoelectric element PZq[m] to such an extent that the ink is not ejected, and the recovery waveform WK for driving the piezoelectric element PZq[m] to such an extent that the state of the nozzle Nz[m] corresponding to the piezoelectric element PZq[m] is recovered and causing the air bubble generated in the nozzle Nz[m] to flow into the individual flow path RJ[m] provided with the pressure chamber CBq[m] to drive the piezoelectric element PZq[m] to such an extent that the state of the nozzle Nz[m] is recovered.

According to the above aspect, with the application of the recovery waveform WK to the piezoelectric element PZq[m] via the internal wiring LHb, the occurrence of the short circuit or the like occurring when the recovery waveform WK is applied via the internal wiring LHc can be avoided, and the state of the nozzle Nz[m] can be recovered by the recovery waveform WK causing the air bubble in the nozzle Nz[m] to flow into the individual flow path RJ[m].

### 2. Second Embodiment

In the first embodiment, depending on whether or not the liquid ejecting head HU is at the position facing the medium PP, the recovery waveform WK is applied to the piezoelectric element PZq, or any one of the ejection waveform and the micro-vibration waveform WB is applied to the piezoelectric element PZq. On the other hand, in a second embodiment, depending on whether or not the recording operation is executed in the recording period Tu[i], the recovery waveform WK is applied to the piezoelectric element PZq, or any one of the ejection waveform and the micro-vibration waveform WB is applied to the piezoelectric element PZq. Hereinafter, the second embodiment will be described.

### 2-1. Operation of Second Embodiment

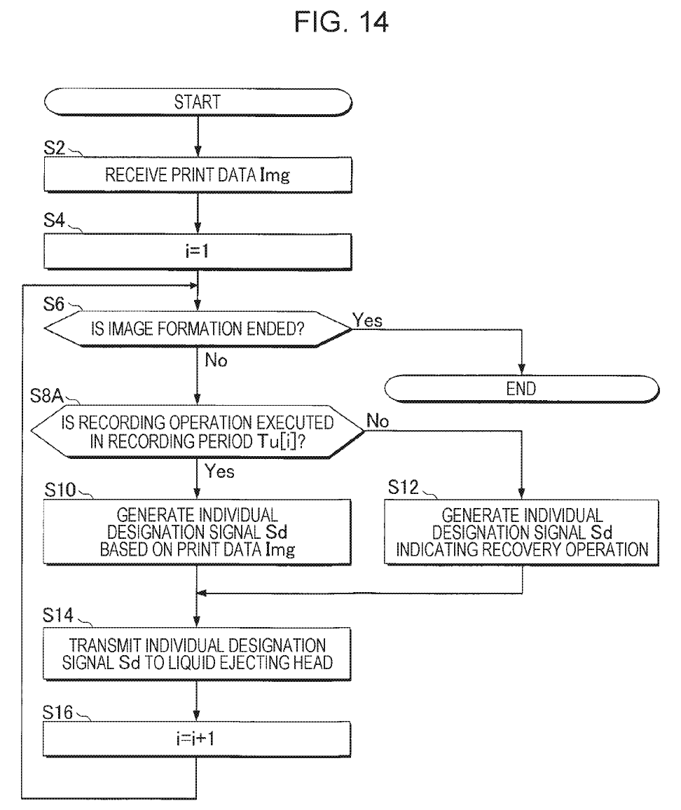

FIG. 14 is a flowchart showing an operation of the control section 6 according to the second embodiment. The flowchart shown in FIG. 14 is different from the flowchart shown in FIG. 12 in that step S8A is executed instead of step S8 in the flowchart shown in FIG. 12. Hereinafter, only differences from the flowchart shown in FIG. 12 will be described.

When the determination result in step S6 is negative, the control section 6 determines in step S8A whether or not to execute the recording operation in the recording period Tu[i]. Specifically, the control section 6 determines, based on the print data Img, whether or not there is one or more piezoelectric elements PZq, among all the piezoelectric elements PZq of the liquid ejecting head HU, that execute the ejection operation in the recording period Tu[i]. The control section 6 executes the processing in step S10 when the determination result in step S8A is positive, and executes the processing in step S12 when the determination result in step S8A is negative.

An execution example of the flowchart shown in FIG. 12 will be described with reference to FIG. 13. The liquid ejecting head HU at the points in time t1, t4, t5, t6, and t8 does not overlap the range Pic in plan view, that is, does not execute the recording operation. Therefore, at the points in time t1, t4, t5, t6, and t8, the control section 6 in the second embodiment determines that a determination result in step S8A is negative, and generates, in step S12, the individual designation signal Sd indicating the recovery operation. On the other hand, in plan view, the liquid ejecting head HU at the points in time t2, t3, and t7 overlaps the range Pic, that is, the recording operation is executed. Therefore, at the points in time t2, t3, and t7, the control section 6 in the second embodiment determines that the determination result in step S8A is positive, and generates, in step S10, the individual designation signal Sd based on the print data Img.

### 2-2. Summary of Second Embodiment

The liquid ejecting head HU according to the second embodiment executes the recording operation of ejecting the ink from one or more nozzles Nz among the M nozzles Nz to the medium PP, and the drive circuit 81 executes, when the recording operation is executed, an operation selected by the control section 6 out of the ejection operation of applying the ejection waveform via the internal wiring LHb and the operation of applying the micro-vibration waveform WB via the internal wiring LHc, and executes, when the recording operation is not executed, the operation of applying the recovery waveform WK via the internal wiring LHb.

When the recording operation is not executed, the ink is not ejected from all the nozzles Nz of the liquid ejecting head HU. Therefore, according to the second embodiment, as in the first embodiment, since the recovery waveform WK is applied to the piezoelectric element PZq at the timing at which the quality of the image is not affected even when the recovery waveform WK is applied to the piezoelectric element PZq, the quality of the image formed at the medium PP can be maintained and the state of the nozzle Nz can be recovered. As understood from the description of FIG. 13, the liquid ejecting head HU at the point in time t6 preferably executes the recovery operation. Therefore, in the second embodiment, an opportunity to execute the recovery operation is increased as compared with the first embodiment, and thus an opportunity to recover the state of the nozzle Nz can be increased. On the other hand, in the second embodiment, in step S8A, since there is a need to determine whether or not there is one or more piezoelectric elements PZq that execute the ejection operation for all the piezoelectric elements PZq of the liquid ejecting head HU, the larger the number of piezoelectric elements PZq of the liquid ejecting head HU, the longer an execution period of step S8A. On the other hand, the processing of step S8 in the first embodiment is fixed regardless of the number of piezoelectric elements PZq of the liquid ejecting head HU, and the execution period of step S8 tends to be shorter than the execution period of step S8A. Therefore, in the first embodiment, a period required for the operation of the control section 6 can be shortened, as compared with the second embodiment.

The second embodiment may also be applied to the first embodiment. For example, when the determination result in step S8 is positive, the control section 6 may execute the processing of step S8A.

### 3. Third Embodiment

In a third embodiment, the control section 6 switches the waveform to be supplied to the ejection drive signal Com_A2 in accordance with whether or not the recording operation is required to be executed. Hereinafter, the third embodiment will be described.

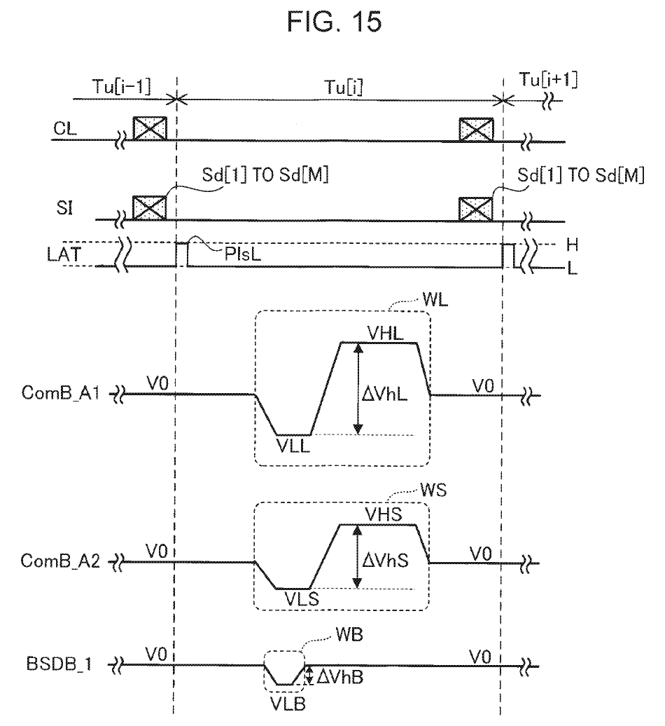

FIG. 15 is a timing chart for describing an operation of the ink jet printer 1 in the recording period Tu[i] when the recording operation is required to be executed. When the recording operation is required to be executed is when the determination result in step S8 in the first embodiment is positive, or when the determination result in step S8A in the second embodiment is positive. FIG. 15 illustrates the ejection drive signal ComB_A1 when the recording operation is required to be executed, the ejection drive signal ComB_A2 when the recording operation is required to be executed, and the micro-vibration drive signal BSDB_1 when the recording operation is required to be executed.

As shown in FIG. 15, the ejection drive signal ComB_A1 has one large-amount ejection waveform WL in one recording period Tu. The ejection drive signal ComB_A2 has one small-amount ejection waveform WS in one recording period Tu. The micro-vibration drive signal BSDB_1 has one micro-vibration waveform WB in one recording period Tu.

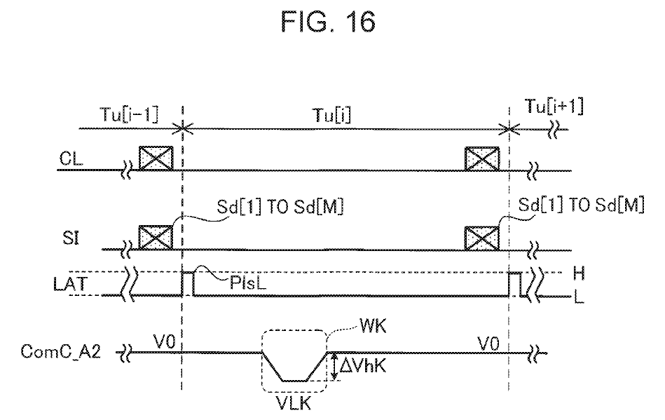

FIG. 16 is a timing chart for describing an operation of the ink jet printer 1 in the recording period Tu[i] when the recording operation is not required to be executed. When the recording operation is not required to be executed is when the determination result in step S8 in the first embodiment is negative or when the determination result in step S8A in the second embodiment is negative. FIG. 16 illustrates the ejection drive signal ComC_A2 when the recording operation is not required to be executed.

As shown in FIG. 16, the ejection drive signal ComC_A2 has one recovery waveform WK in one recording period Tu. The ejection drive signal Com_A1 when the recording operation is not required to be executed may be the same as or different from the ejection drive signal ComB_A1. Similarly, the micro-vibration drive signal BSD_1 when the recording operation is not required to be executed may be the same as or different from the micro-vibration drive signal BSDB_1.

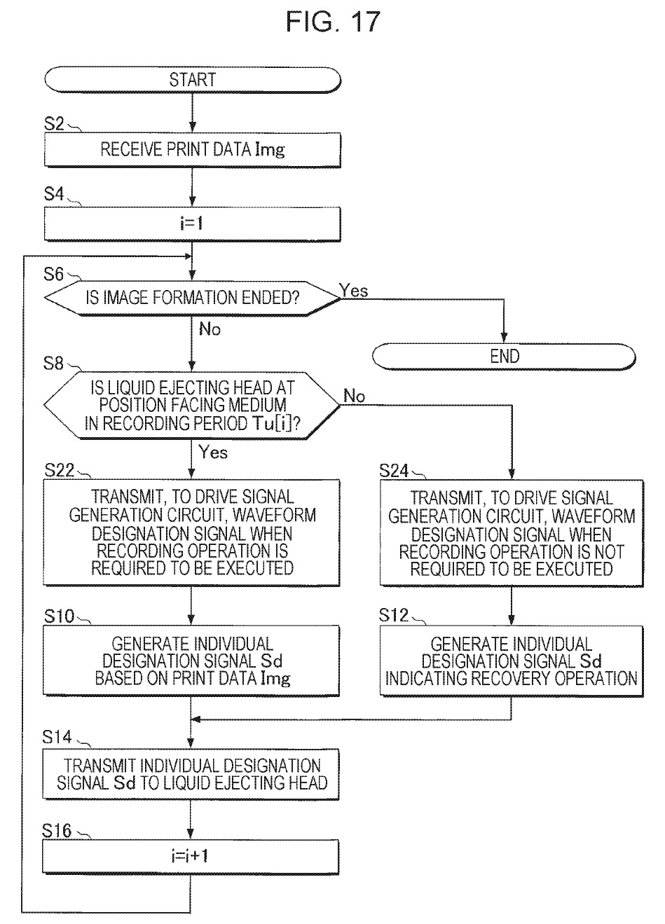

FIG. 17 is a flowchart showing an operation of the control section 6 according to the third embodiment. The flowchart shown in FIG. 17 is different from the flowchart shown in FIG. 12 in that the processing of step S22 is executed when the determination result of step S8 in the flowchart shown in FIG. 12 is positive, and the processing of step S24 is executed when the determination result of step S8 is negative. Hereinafter, only differences from the flowchart shown in FIG. 12 will be described.

When the determination result in step S8 is positive, the control section 6 in the third embodiment transmits, to the drive signal generation circuit 2, the waveform designation signal dCom when the recording operation is required to be executed, in step S22. Specifically, the control section 6 in the third embodiment outputs the waveform designation signal dCom_A1 that defines the ejection drive signal ComB_A1 to the ejection drive signal generation circuit 21_A1, outputs the waveform designation signal dCom_A2 that defines the ejection drive signal ComB_A2 to the ejection drive signal generation circuit 21_A2, and outputs the waveform designation signal dCom_D1 that defines the micro-vibration drive signal BSDB_1 to the micro-vibration drive signal generation circuit 22_1. After the processing of step S22 is ended, the control section 6 in the third embodiment executes the processing of step S10.

When the determination result in step S8 is negative, the control section 6 in the third embodiment transmits, to the drive signal generation circuit 2, the waveform designation signal dCom when the recording operation is not required to be executed, in step S24. Specifically, the control section 6 in the third embodiment outputs, to the ejection drive signal generation circuit 21_A2, the waveform designation signal dCom_A2 that defines the ejection drive signal ComC_A2. After the processing of step S24 is ended, the control section 6 in the third embodiment executes the processing of step S12.

### 4. Modification Examples

Each of the aspects illustrated above may be variously modified. Specific modified aspects that may be employed for each of the above aspects will be exemplified below. Two or more aspects optionally selected from the following exemplifications may be merged as appropriate within a range not inconsistent with each other.

### 4-1. First Modification Example

In each aspect described above, the recovery waveform WK is for driving the piezoelectric element PZq[m] to such an extent that the ink is not ejected, but the present disclosure is not limited thereto. For example, the recovery waveform WK may be a waveform for driving the piezoelectric element PZq[m] to such an extent that the ink is ejected.

### 4-2. Second Modification Example

In each aspect described above, the intensity of the recovery waveform WK is lower than the intensity of the small-amount ejection waveform WS, but the present disclosure is not limited thereto. For example, the intensity of the recovery waveform WK may be higher than the intensity of the small-amount ejection waveform WS.

### 4-3. Third Modification Example

In each aspect described above, the drive circuit 81 applies the recovery waveform WK to the piezoelectric element PZq via the internal wiring LHb, but the present disclosure is not limited thereto. For example, the drive circuit 81 may apply the recovery waveform WK to the piezoelectric element PZq via the internal wiring LHa.

### 4-4. Fourth Modification Example

In each aspect described above, the serial-type ink jet printer 1, which reciprocates the liquid ejecting head HU in the direction along the X-axis, is exemplified, but the present disclosure is not limited to such an aspect. The ink jet printer 1 may be a line-type liquid ejecting apparatus in which a plurality of nozzles Nz are distributed over the entire width of the medium PP.

### 4-5. Other Modification Examples

The above ink jet printer 1 may be employed in various apparatuses such as a facsimile machine and a copier, in addition to an apparatus dedicated to printing. However, the application of the recording apparatus of the present disclosure is not limited to the printing. For example, a recording apparatus that ejects a solution of a coloring material is used as a manufacturing apparatus that forms a color filter of a liquid crystal display apparatus. Further, a recording apparatus that ejects a solution of a conductive material is used as a manufacturing apparatus that forms wiring and an electrode of a wiring substrate.

What is claimed is:

1. A liquid ejecting apparatus using a liquid ejecting head comprising:
a plurality of piezoelectric elements;
a plurality of pressure chambers to which pressure is applied to an internal liquid by drive of each of the plurality of piezoelectric elements;
a plurality of nozzles through which the liquid is able to be ejected by the pressure applied by each of the plurality of pressure chambers;
a drive circuit that drives each of the plurality of piezoelectric elements;
a first wiring that is switched whether or not to be electrically coupled to each of the plurality of piezoelectric elements under control of the drive circuit; and
a second wiring that is switched whether or not to be electrically coupled to each of the plurality of piezoelectric elements, separately from the first wiring, under control of the drive circuit, wherein
the drive circuit applies an ejection waveform for driving one piezoelectric element among the plurality of piezoelectric elements to such an extent that the liquid is ejected, via the first wiring, to the one piezoelectric element, applies a micro-vibration waveform for driving the one piezoelectric element to such an extent that the liquid is not ejected, via the second wiring, to the one piezoelectric element, and applies a recovery waveform for driving the one piezoelectric element to such an extent that a state of a nozzle corresponding to the one piezoelectric element is recovered, via the first wiring, to the one piezoelectric element.

2. The liquid ejecting apparatus according to claim 1, wherein
the recovery waveform is for driving the one piezoelectric element to such an extent that the liquid is not ejected.

3. The liquid ejecting apparatus according to claim 1, wherein
an intensity of the recovery waveform is higher than an intensity of the micro-vibration waveform.

4. The liquid ejecting apparatus according to claim 1, wherein
an intensity of the recovery waveform is lower than an intensity of the ejection waveform.

5. The liquid ejecting apparatus according to claim 1, wherein
the liquid ejecting head further includes
a plurality of individual flow paths,
a common supply flow path that communicates in common with the plurality of individual flow paths to supply the liquid to each of the plurality of individual flow paths, and
a common discharge flow path that communicates in common with the plurality of individual flow paths to discharge the liquid from each of the plurality of individual flow paths, and
each of the plurality of individual flow paths has one or more pressure chambers among the plurality of pressure chambers and communicates with one nozzle among the plurality of nozzles.

6. The liquid ejecting apparatus according to claim 5, wherein
the recovery waveform is for causing an air bubble generated in a nozzle corresponding to the one piezoelectric element to flow into an individual flow path having a pressure chamber corresponding to the one piezoelectric element, and thus for driving the one piezoelectric element to such an extent that the state of the nozzle corresponding to the one piezoelectric element is recovered.

7. The liquid ejecting apparatus according to claim 1, wherein
the liquid ejecting head ejects the liquid to a medium, and
the drive circuit
executes, when the liquid ejecting head is at a position facing the medium, an operation selected from an operation of applying the ejection waveform via the first wiring and an operation of applying the micro-vibration waveform via the second wiring, and
executes, when the liquid ejecting head is at a position not facing the medium, an operation of applying the recovery waveform via the first wiring.

8. The liquid ejecting apparatus according to claim 1, wherein
the liquid ejecting head executes a recording operation of ejecting the liquid to a medium from one or more nozzles among the plurality of nozzles, and
the drive circuit
executes, when the recording operation is executed, an operation selected from an operation of applying the ejection waveform via the first wiring and an operation of applying the micro-vibration waveform via the second wiring, and
executes, when the recording operation is not executed, an operation of applying the recovery waveform via the first wiring.

9. The liquid ejecting apparatus according to claim 1, wherein
a withstand voltage characteristic of the second wiring is lower than a withstand voltage characteristic of the first wiring.

10. A liquid ejecting apparatus using a liquid ejecting head comprising:
a plurality of piezoelectric elements;
a plurality of pressure chambers to which pressure is applied to an internal liquid by drive of each of the plurality of piezoelectric elements;
a plurality of nozzles through which the liquid is able to be ejected by the pressure applied by each of the plurality of pressure chambers;
a drive circuit that drives each of the plurality of piezoelectric elements;
a first wiring that is switched whether or not to be electrically coupled to each of the plurality of piezoelectric elements under control of the drive circuit; and
a second wiring that is switched whether or not to be electrically coupled to each of the plurality of piezoelectric elements, separately from the first wiring, under control of the drive circuit, wherein
the drive circuit applies an ejection waveform for driving one piezoelectric element among the plurality of piezoelectric elements to such an extent that the liquid is ejected, via the first wiring, to the one piezoelectric element, applies a micro-vibration waveform for driving the one piezoelectric element to such an extent that the liquid is not ejected, via the second wiring, to the one piezoelectric element, and applies a recovery waveform having an intensity that is higher than an intensity of the micro-vibration waveform and is lower than an intensity of the ejection waveform, via the first wiring, to the one piezoelectric element.

11. A liquid ejecting apparatus using a liquid ejecting head comprising:
a plurality of piezoelectric elements;
a plurality of pressure chambers to which pressure is applied to an internal liquid by drive of each of the plurality of piezoelectric elements;
a plurality of nozzles through which the liquid is able to be ejected by the pressure applied by each of the plurality of pressure chambers;
a plurality of individual flow paths;
a common supply flow path that communicates in common with the plurality of individual flow paths to supply the liquid to the plurality of individual flow paths;
a common discharge flow path that communicates in common with the plurality of individual flow paths to discharge the liquid from the plurality of individual flow paths; and
a drive circuit that drives each of the plurality of piezoelectric elements, wherein
each of the plurality of individual flow paths has one or more pressure chambers among the plurality of pressure chambers and communicates with one nozzle among the plurality of nozzles, and
the drive circuit applies, to one piezoelectric element among the plurality of piezoelectric elements, an ejection waveform for driving the one piezoelectric element to such an extent that the liquid is ejected, a micro-vibration waveform for driving the one piezoelectric element to such an extent that the liquid is not ejected, and a recovery waveform for driving the one piezoelectric element to such an extent that a state of a nozzle corresponding to the one piezoelectric element is recovered and for causing an air bubble generated in the nozzle corresponding to the one piezoelectric element to flow into an individual flow path having a pressure chamber corresponding to the one piezoelectric element and thus for driving the one piezoelectric element to such an extent that the state of the nozzle corresponding to the one piezoelectric element is recovered.
